(19) United States
(12) Patent Application Publication
(10) Pub. No.: US 2019/0047694 A1
(43) Pub. Date: Feb. 14, 2019

(54) AERIAL PLATFORMS FOR AERIAL SPRAYING AND METHODS FOR CONTROLLING THE SAME

(71) Applicant: ISRAEL AEROSPACE INDUSTRIES LTD., Lod (IL)

(72) Inventors: Lior ZIVAN, Yad Hanna (IL); Guy DEKEL, Kazir (IL)

(21) Appl. No.: 16/075,341

(22) PCT Filed: Feb. 1, 2017
(86) PCT No.: PCT/IL2017/050119

§ 371 Date: Aug. 3, 2018

(30) Foreign Application Priority Data
Feb. 3, 2016 (IL) 243942

(51) Int. Cl. B64C 31/036; B64C 39/02; B64D 1/18; G01C 5/00

(52) U.S. Cl. CPC B64C 31/036; B64C 39/024; B64D 1/18; B64C 2201/145; B64C 2201/107; B64C 2201/128; G01C 5/005

(57) ABSTRACT

There is provided an aerial platform comprising a spraying module, one or more actuators operatively coupled to the spraying module, at least a sensor for acquiring data indicative of altitude, wherein at least a controller is configured to control a position of the spraying module relatively to the aerial platform based on control signals generated during control cycles and applicable to the one or more actuators, the controlling comprising cyclically acquiring with said sensor data indicative of an altitude of a surface area in the flight path direction of the aerial platform, wherein said surface area is to be sprayed in a next control cycle, generating a control signal based on at least said acquired data, so as to maintain the altitude of the spraying module at a required distance of the altitude of the surface, and applying the generated control signal to the one or more actuators. There is also provided methods and systems for controlling a motion of the spraying module.

### TECHNOLOGICAL FIELD

The presently disclosed subject matter relates to aerial spraying, in particular to methods, systems and air platforms therefor.

### BACKGROUND ART

References considered to be relevant as background to the presently disclosed subject matter are listed below:
U.S. Pat. No. 3,682,418
U.S. Pat. No. 4,522,841
U.S. Pat. No. 4,522,841
GB 1,042,932
WO 2002/075235
CN 204236779
CN 104494816
FR 1,026,012
SU 515691
BR 102013018685
JP 2009-269493

Acknowledgement of the above references herein is not to be inferred as meaning that these are in any way relevant to the patentability of the presently disclosed subject matter.

### BACKGROUND

Spraying of crops from an agricultural aircraft is commonly referred to as “crop dusting” or “aerial application” or “agricultural spraying”. While such spraying typically involves crop protection products, the method is also applied for planting some types of seeds. The aerial application specifically of fertilizer is also known as “aerial topdressing”.

Conventionally, many agricultural aircraft are in the form of manned, fixed wing aircraft, specifically designed for the purpose of aerial application, though rotor wing aircraft such as helicopters are also used for this purpose. Some conventional agricultural aircraft can carry about 3,000 liters of crop protection product for spraying crops therewith. Some conventional agricultural aircraft are also sometimes used for firefighting tasks, referred to herein as “water bombing”, for example for wildfires, serving as water bombers.

Examples of manned, fixed wing conventional agricultural aircraft include the S-1, and the Grumman G-164 Ag-Cat.

Unmanned Aerial Vehicles (UAV's) have also been used for agricultural spraying since the late 1990's, for example in Japan, South Korea and the USA, and include the Yamaha R-MAX UAV.

By way of non limiting example, GB 1,042,932 discloses an aircraft having a spray-bar suspended on two linear actuators, e.g. hydraulic, pneumatic or electrically operated jacks automatically controlled by a summing and amplifying unit to keep the spray-bar substantially parallel to and at a substantially constant height above the ground which is being sprayed. Demand signals indicating the required heights of the aircraft and spray bar are fed into the summing and amplifying unit, as also are signals from height-aboveground measuring devices. The signals are algebraically summed and actuator extension error signals are fed to servo-valves to effect extension or retraction of the actuators until the error signals are both zero. The aircraft may also include means which relays height error to a system which controls the aircraft's vertical movements. When traversing rough ground or ground carrying a standing crop filters may be included in the summing and amplifying networks to eliminate unwanted high frequency components.

Another method of spraying crops relies on the use of land vehicles, such as tractors for example. The tractors are generally driven by an operator (or automatically, for example using an automatic steering system, for example the Trimble Autopilot system) and carry a spray bar for dusting the chemical products along the ground path of the tractor. The operator drives the tractor so as to cover the whole surface to be sprayed. However tractors cannot general operate effectively, or at all, for this purpose, when the ground surface becomes waterlogged, for example. Furthermore, tractors can also cause earth compaction (because of their high weight) and can adversely affect capability for the earth to become aerated at the end of the season. Furthermore use of tractors requires part of the ground surface of the field to be reserved as the tractor route (typically about 6%), and thus decreases the available surface if the field for crop growing.

### General Description

The term “aerial spraying” is used herein to include one or more of: dusting, crop dusting, aerial application, crop spraying, aerial topdressing, water bombing, agricultural spraying.

According to a first aspect of the presently disclosed subject matter there is provided an aerial spraying assembly, comprising:
a manifold member, comprising a first plurality of spray nozzles for enabling aerial spraying of a fluid material therefrom;
and further comprising a support structure, the support structure being according to one or more of the following:
   the support structure including a base structure and at least one non-rigid support for supporting the manifold member in spaced spatial relationship with the base structure via said at least one non-rigid support, the base structure being fixedly mountable to an aerial platform;
   the support structure including a base structure and at least one non-rigid support for supporting the manifold member in a variable spaced spatial relationship with the base structure via said at least one non-rigid support, the base structure being fixedly mountable to an aerial platform;
   the support structure including a base structure and at least two supports for supporting the manifold member in spaced spatial relationship with the base structure via said at least two supports, wherein at least one said support is a non-rigid support, the base structure being fixedly mountable to an aerial platform;
   the support structure including a base structure and at least two supports for supporting the manifold member in variable spaced spatial relationship with the base structure via said at least two supports, wherein at least one said support is a non-rigid support, the base structure being fixedly mountable to an aerial platform.

Herein, the term “aerial platform” is used interchangeably with “air platform”, “air platform”, and so on.

For example, the aerial spraying assembly further comprises an actuation system for selectively changing said spaced spatial relationship. For example, said actuation system comprises at least one actuator operatively coupled to each said non-rigid support, configured for selectively changing a respective length of the respective said non-rigid support defining a respective spacing between the manifold member and the base structure at the respective said non-rigid support, to thereby change said spaced spatial relationship.

In a first example, the aerial spraying assembly comprises at least two said non-rigid supports spaced from one another along a lateral axis, and wherein said actuation system can be operated to change said spaced spatial relationship by controlling at least one of a vertical spacing and a roll orientation of the manifold member with respect to the base structure.

In a second example, the aerial spraying assembly comprises at least two said non-rigid supports spaced from one another along a longitudinal axis, and wherein said actuation system can be operated to change said spaced spatial relationship by controlling at least one of a vertical spacing and a pitch orientation of the manifold member with respect to the base structure.

Optionally to the above, said base structure comprises a first base element and a second base element axially spaced from the first base element along a forward-aft axis.

In a third example, and additionally or alternatively to the above, the aerial spraying assembly comprises at least three said non-rigid supports, wherein two said non-rigid supports are spaced from one another along a lateral axis, and spaced from a third said non-rigid support along a longitudinal axis, and wherein said actuation system can be operated to change said spaced spatial relationship by controlling at least one of a vertical spacing, a roll orientation and a pitch orientation of the manifold member with respect to the base structure. For example, said at least three non-rigid supports include a central said non-rigid support, a port said non-rigid support, and a starboard said non-rigid support. For example, said port non-rigid support and said starboard non-rigid support are coupled to one of the first base element and the second base element, and wherein said central non-rigid support is coupled to the other one of the first base element and the second base element.

In a fourth example, the aerial spraying assembly comprises at least two said non-rigid supports and a third, adjustable support, wherein said two non-rigid supports are spaced from one another along a lateral axis, wherein said two non-rigid supports are spaced from said adjustable support along a longitudinal axis, and wherein said actuation system can be operated to change said spaced spatial relationship by controlling at least one of a vertical spacing, a roll orientation and a pitch orientation of the manifold member with respect to the base structure. For example, said at least two non-rigid supports include a port said non-rigid support, and a starboard said non-rigid support, and wherein said port non-rigid support and said starboard non-rigid support are coupled to one of the first base element and the second base element, and wherein said adjustable support is coupled to the other one of the first base element and the second base element. For example, said adjustable support is configured as a telescopic support.

Additionally or alternatively, and referring to each one of the third or fourth examples above, said port non-rigid support and said starboard non-rigid support are coupled to the first base element, and wherein said first base element is formed as an elongate load bearing member aligned along a port-starboard axis. For example said elongate load bearing member is articulated and selectively foldable to provide a compact configuration al least along the port-starboard axis.

Additionally or alternatively to any one of the above examples and other examples, said manifold member comprises at least one manifold portion, each said manifold portion comprising at least one fluid inlet, a second plurality of said spray nozzles, and at least one lumen providing fluid communication between the at least one fluid inlet and the second plurality of said spray nozzles. For example, the aerial spraying assembly comprises at least one port said manifold portion and at least one starboard said manifold portion. For example, said port manifold portion and said starboard manifold portion are joined together at one respective end thereof at a joint to form a V-shaped configuration.

Additionally or alternatively to any one of the above examples and other examples, said manifold member is articulated and selectively foldable to provide a compact configuration al least along the port-starboard axis.

For example, said at least three non-rigid supports include said central non-rigid support, said port non-rigid support, and said starboard non-rigid support, and wherein said central non-rigid support is fixedly connected to said joint, wherein said port non-rigid support is fixedly connected to said port manifold portion, and wherein said starboard non-rigid is fixedly connected to said starboard manifold portion.

Additionally or alternatively to any one of the above examples and other examples, each said non-rigid support is configured for being load bearing in tension and for being non-load bearing in compression. For example, each said non-rigid support comprises a cable fixedly connected at one end thereof to the manifold member, and wherein another end of said cable is operatively connected to the actuation system.

Additionally or alternatively to any one of the above examples and other examples, the aerial spraying assembly further comprises a controller for controlling operation of the actuation system to thereby selectively provide a desired said spaced spatial relationship.

Additionally or alternatively to any one of the above examples and other examples, the aerial spraying assembly further comprises at least one ground surface sensor for providing surface data indicative of the three dimensional topography of the ground surface over which the aerial spraying assembly is operable to provide aerial spraying of the fluid material thereonto.

Additionally or alternatively to any one of the above examples and other examples, the aerial spraying assembly further comprises at least one ground surface sensor for providing surface data indicative of the three dimensional topography of the ground surface over which the aerial spraying assembly is operable to provide aerial spraying of the fluid material thereonto, and further comprising a virtual three dimensional map of the ground surface.

Additionally or alternatively to any one of the above examples and other examples, the aerial spraying assembly further comprises at least one vehicle inertial sensor for providing inertial data for the aerial platform when the aerial spraying assembly is mounted thereto. For example, said inertial data is indicative of one or more of the position, orientation, altitude with respect to sea level, height above ground, heading, and flying direction of the aerial platform with respect to the Earth.

Additionally or alternatively to any one of the above examples and other examples, the aerial spraying assembly further comprises at least one manifold inertial sensor for providing inertial data for the manifold member. For example, said inertial data is indicative of one or more of the position, orientation, altitude with respect to sea level, height above ground, and flying direction of the manifold member with respect to air vehicle and/or with respect to a ground surface.

Additionally or alternatively to any one of the above examples and other examples, the aerial spraying assembly further comprises at least one manifold positional sensor for providing positional data of the manifold member relative to the support structure.

Additionally or alternatively to any one of the above examples and other examples, the aerial spraying assembly further comprises at least one tank for holding therein a quantity of the fluid material, said tank being in selective fluid communication with said first plurality of spray nozzles. For example, the aerial spraying assembly comprises at least one conduit for transferring said fluid material from said at least one tank to said manifold member. For example, said at least one conduit is different from said at least one non-rigid support. Alternatively, said at least one conduit is integral with one said non-rigid support; for example the integrated conduit/non-rigid support can be in the form of a hollow flexible tube.

According to a second aspect of the presently disclosed subject matter there is provided an aerial platform comprising the aerial spraying assembly as defined herein with respect to the first aspect of the presently disclosed subject matter.

For example, the aerial platform is in the form of an ultralight air vehicle, and thus includes any one of: powered parachute air platforms, powered hang glider air platforms, powered paraglider air platforms, and so on.

Alternatively, for example, the aerial platform is in the form of a fixed wing air vehicle.

Alternatively, for example, the aerial platform is in the form of a rotary wing air vehicle, including for example multi-rotor air vehicles.

Additionally or alternatively to the above, the aerial platform can be an unmanned air vehicle (UAV), or as manned air vehicle.

According to a third aspect of the presently disclosed subject matter there is provided an aerial spraying assembly configured for selectively deploying between a compact configuration and a deployed configuration, comprising:
a manifold member, comprising a first plurality of spray nozzles for enabling aerial spraying of a fluid material therefrom at least in said deployed configuration, the manifold member being suspendable from a base structure via at least one non-rigid support (or wherein the manifold member is suspendable from a base structure via at least two supports, wherein at least one said support is a non-rigid support) at least during aerial spraying, the base structure being fixedly mountable to an aerial platform;
wherein in the compact configuration the aerial spraying assembly is circumscribed by an imaginary geometrical envelope, and wherein in the deployed configuration, at least a part of the aerial spraying assembly is outside of the imaginary geometrical envelope.

For example, the manifold member and the base structure are each articulated to enable the aerial spraying system to selectively deploy from said compact configuration to said deployed configuration.

For example, the manifold member is suspendable from the base structure in variable spaced spatial relationship with the base structure via said non-rigid support (or said at least two supports wherein at least one said support is a non-rigid support).

For example, the aerial spraying assembly further comprises an actuation system for selectively changing said spaced spatial relationship. For example, said actuation system comprises at least one actuator operatively coupled to each said non-rigid support, configured for selectively changing a respective length of the respective said non-rigid support defining a respective spacing between the manifold member and the base structure at the respective said non-rigid support, to thereby change said spaced spatial relationship.

In a first example according to the third aspect of the presently disclosed subject matter, the aerial spraying assembly comprises at least two said non-rigid supports spaced from one another along a lateral axis, and wherein said actuation system can be operated to change said spaced spatial relationship by controlling at least one of a vertical spacing and a roll orientation of the manifold member with respect to the base structure.

In a second example according to the third aspect of the presently disclosed subject matter, the aerial spraying assembly comprises at least two said non-rigid supports spaced from one another along a longitudinal axis, and wherein said actuation system can be operated to change said spaced spatial relationship by controlling at least one of a vertical spacing and a pitch orientation of the manifold member with respect to the base structure.

Optionally to the above, said base structure comprises a first base element and a second base element axially spaced from the first base element along a forward-aft axis.

In a third example according to the third aspect of the presently disclosed subject matter, and additionally or alternatively to the above, the aerial spraying assembly comprises at least three said non-rigid supports, wherein two said non-rigid supports are spaced from one another along a lateral axis, and spaced from a third said non-rigid support along a longitudinal axis, and wherein said actuation system can be operated to change said spaced spatial relationship by controlling at least one of a vertical spacing, a roll orientation and a pitch orientation of the manifold member with respect to the base structure. For example, said at least three non-rigid supports include a central said non-rigid support, a port said non-rigid support, and a starboard said non-rigid support. For example, said port non-rigid support and said starboard non-rigid support are coupled to one of the first base element and the second base element, and wherein said central non-rigid support is coupled to the other one of the first base element and the second base element.

In a fourth example according to the third aspect of the presently disclosed subject matter, the aerial spraying assembly comprises at least two said non-rigid supports and a third, adjustable support, wherein said two non-rigid supports are spaced from one another along a lateral axis, wherein said two non-rigid supports are spaced from said adjustable support along a longitudinal axis, and wherein said actuation system can be operated to change said spaced spatial relationship by controlling at least one of a vertical spacing, a roll orientation and a pitch orientation of the manifold member with respect to the base structure. For example, said at least two non-rigid supports include a port said non-rigid support, and a starboard said non-rigid support, and wherein said port non-rigid support and said starboard non-rigid support are coupled to one of the first base element and the second base element, and wherein said adjustable support is coupled to the other one of the first base element and the second base element. For example, said adjustable support is configured as a telescopic support.

Additionally or alternatively, and referring to each one of the third or fourth examples above according to the third aspect of the presently disclosed subject matter, said port non-rigid support and said starboard non-rigid support are coupled to the first base element, and wherein said first base element is formed as an elongate load bearing member aligned along a port-starboard axis. For example said elongate load bearing member is articulated and selectively foldable to provide a compact configuration al least along the port-starboard axis.

Additionally or alternatively to any one of the above examples and other examples, according to the third aspect of the presently disclosed subject matter, said manifold member comprises at least one manifold portion, each said manifold portion comprising at least one fluid inlet, a second plurality of said spray nozzles, and at least one lumen providing fluid communication between the at least one fluid inlet and the second plurality of said spray nozzles. For example, the aerial spraying assembly comprises at least one port said manifold portion and at least one starboard said manifold portion. For example, said port manifold portion and said starboard manifold portion are joined together at one respective end thereof at a joint to form a V-shaped configuration.

Additionally or alternatively to any one of the above examples and other examples, according to the third aspect of the presently disclosed subject matter, said manifold member is articulated and selectively foldable to provide a compact configuration al least along the port-starboard axis.

For example, said at least three non-rigid supports include said central non-rigid support, said port non-rigid support, and said starboard non-rigid support, and wherein said central non-rigid support is fixedly connected to said joint, wherein said port non-rigid support is fixedly connected to said port manifold portion, and wherein said starboard non-rigid is fixedly connected to said starboard manifold portion.

Additionally or alternatively to any one of the above examples and other examples, according to the third aspect of the presently disclosed subject matter, each said non-rigid support is configured for being load bearing in tension and for being non-load bearing in compression. For example, each said non-rigid support comprises a cable fixedly connected at one end thereof to the manifold member, and wherein another end of said cable is operatively connected to the actuation system.

Additionally or alternatively to any one of the above examples and other examples, according to the third aspect of the presently disclosed subject matter, the aerial spraying assembly further comprises a controller for controlling operation of the actuation system to thereby selectively provide a desired said spaced spatial relationship.

Additionally or alternatively to any one of the above examples and other examples, according to the third aspect of the presently disclosed subject matter, the aerial spraying assembly further comprises at least one ground surface sensor for providing surface data indicative of the three dimensional topography of the ground surface over which the aerial spraying assembly is operable to provide aerial spraying of the fluid material thereonto.

Additionally or alternatively to any one of the above examples and other examples, according to the third aspect of the presently disclosed subject matter, the aerial spraying assembly further comprises at least one ground surface sensor for providing surface data indicative of the three dimensional topography of the ground surface over which the aerial spraying assembly is operable to provide aerial spraying of the fluid material thereonto, and further comprising a virtual three dimensional map of the ground surface.

Additionally or alternatively to any one of the above examples and other examples, according to the third aspect of the presently disclosed subject matter, the aerial spraying assembly further comprises at least one vehicle inertial sensor for providing inertial data for the aerial platform when the aerial spraying assembly is mounted thereto. For example, said inertial data is indicative of one or more of the position, orientation, altitude with respect to sea level, height above ground, heading, and flying direction of the aerial platform with respect to the Earth.

Additionally or alternatively to any one of the above examples and other examples, according to the third aspect of the presently disclosed subject matter, the aerial spraying assembly further comprises at least one manifold inertial sensor for providing inertial data for the manifold member. For example, said inertial data is indicative of one or more of the position, orientation, altitude with respect to sea level, height above ground, and flying direction of the manifold member with respect to air vehicle and/or with respect to a ground surface.

Additionally or alternatively to any one of the above examples and other examples, according to the third aspect of the presently disclosed subject matter, the aerial spraying assembly further comprises at least one manifold positional sensor for providing positional data of the manifold member relative to the support structure.

Additionally or alternatively to any one of the above examples and other examples, according to the third aspect of the presently disclosed subject matter, the aerial spraying assembly further comprises at least one tank for holding therein a quantity of the fluid material, said tank being in selective fluid communication with said first plurality of spray nozzles. For example, the aerial spraying assembly comprises at least one conduit for transferring said fluid material from said at least one tank to said manifold member. For example, said at least one conduit is different from said at least one non-rigid support. Alternatively, said at least one conduit is integral with one said non-rigid support; for example the integrated conduit/non-rigid support can be in the form of a hollow flexible tube.

According to a fourth aspect of the presently disclosed subject matter there is provided an aerial platform comprising the aerial spraying assembly as defined herein with respect to the third aspect of the presently disclosed subject matter.

For example, the aerial platform is in the form of an ultralight air vehicle, and thus includes any one of: powered parachute air platforms, powered hang glider air platforms, powered paraglider air platforms, and so on.

Alternatively, for example, the aerial platform is in the form of a fixed wing air vehicle.

Alternatively, for example, the aerial platform is in the form of a rotary wing air vehicle, including for example multi-rotor air vehicles.

Additionally or alternatively to the above, the aerial platform can be an unmanned air vehicle (UAV), or as manned air vehicle.

According to a fifth aspect of the presently disclosed subject matter there is provided an airborne spraying system comprising:
a plurality of aerial platforms, each as defined herein with respect to the second and/or fourth aspect of the presently disclosed subject matter;
a central controller for controlling operation of said plurality of aerial platforms to spray a desired ground zone with the fluid material.

According to a fifth aspect of the presently disclosed subject matter there is provided a method for aerial spraying a fluid material over a desired ground zone, comprising:
(a) providing an aerial platform as defined herein with respect to the second and/or fourth aspect of the presently disclosed subject matter;
(b) selectively operating said aerial spraying assembly to spray the fluid material over the desired ground zone while flying the aerial platform over the desired ground zone.

For example, in step (b) the manifold member is suspended with respect to the aerial platform via said non-rigid supports.

Additionally or alternatively, for example, in step (b) the manifold member is suspended with respect to the aerial platform via said non-rigid supports such as to maintain a generally constant spacing and orientation with respect to a ground surface while flying the aerial platform over the desired ground zone.

Additionally or alternatively, for example, the method comprises operating the aerial spraying system to change a vertical spacing between the manifold member and the aerial platform.

Additionally or alternatively, for example, the method comprises operating the aerial spraying system to change a spatial orientation in pitch of the manifold member with respect to the aerial platform.

Additionally or alternatively, for example, the method comprises operating the aerial spraying system to change a spatial orientation in roll of the manifold member with respect to the aerial platform.

In accordance with the above aspects and/or certain other aspects of the presently disclosed subject matter, there is provided a method of controlling a spraying module of an aerial platform, the spraying module being configured to spray fluid material on a surface, the method comprising, during the flight of the aerial platform, controlling a position of the spraying module relatively to the aerial platform based on control signals generated during control cycles and applicable to one or more actuators operatively coupled to the spraying module, the controlling comprising cyclically acquiring data indicative of an altitude of a surface area in the flight path direction of the aerial platform, wherein said surface area is to be sprayed in a next control cycle, generating a control signal based on at least said acquired data, so as to maintain the altitude of the spraying module at a required distance of the altitude of the surface, and applying the generated control signal to the one or more actuators.

According to some examples, said acquisition of data comprises taking images of the surface area which is to be sprayed in a next control cycle. According to some examples, the method comprises comparing the acquired data with pre-stored reference images of the surface, so as to detect obstacles in the surface. According to some examples, the method comprises performing an analysis of the evolution of the acquired data, so as to detect obstacles in the surface. According to some examples, the method comprises adapting a spraying period of the spraying module and/or a flight path of the aerial platform based on the detection of obstacles. According to some examples, the method comprises planning in advance a flight path of the aerial platform based on pre-stored data on the altitude of surface. According to some examples, the method comprises controlling an inclination of the spraying module with respect to the aerial platform. According to some examples, the method comprises controlling an inclination of the spraying module with respect to the aerial platform so as to maintain the spraying module substantially parallel to the surface. According to some examples, the method comprises controlling an inclination and/or a position of the spraying module with respect to the aerial platform based on predictions of at least the attitude and/or the position of the aerial platform. According to some examples, the spraying module is connected to the aerial platform by at least a non-rigid connection (also referred to interchangeably herein as “non-rigid support”). According to some examples, the method comprises controlling the spraying module to reach a target position, and controlling an acceleration of a motion of the spraying module for reaching said target position. According to some examples, the method comprises controlling a damping in the motion of the spraying module. According to some examples, the method comprises measuring a position and a velocity of the spraying module, and computing a control signal based at least on a damped combination of the measured position and velocity. According to some examples, the method comprises acquiring images of the surface from the aerial platform, identifying particular portions of the surface in the images, and controlling the flight path of the aerial platform based on this identification. According to some examples, the method comprises controlling the flight path of the aerial platform based on this identification, even if an information on the current position of the aerial platform is not available. According to some examples, the particular portions include edges and/or borders of the surface.

In accordance with some aspects of the presently disclosed subject matter, there is provided a method of controlling a spraying module of an aerial platform, the spraying module being loosely connected to the spraying module and being configured to spray fluid material on a surface, the method comprising, during the flight of the aerial platform, controlling the spraying module so as to reach a position target relatively to the aerial platform, and controlling at least an acceleration of the motion of the spraying module for reaching said position target.

According to some examples, the method comprises controlling a damping in the motion of the spraying module. According to some examples, the method comprises introducing a selected damping in the motion of the spraying module which ensures that the position of the spraying module does not go beyond the position target. According to some examples, the method comprises measuring a position and a velocity of the spraying module, and computing a control signal based at least on a damped combination of the measured position and velocity, for controlling the acceleration of the motion of the spraying module. According to some examples, the method comprises controlling a position of the spraying module relatively to the aerial platform based on control signals generated during control cycles and applicable to one or more actuators operatively coupled to the spraying module, the controlling comprising cyclically acquiring data indicative of an altitude of a surface area in the flight path direction of the aerial platform, wherein said surface area is to be sprayed in a next control cycle, generating a control signal based on at least said acquired data, so as to make the spraying module reach a position target which is at a required distance of the altitude of the surface, and applying the generated control signal to the one or more actuators.

In accordance with some aspects of the presently disclosed subject matter, there is provided an aerial platform comprising a spraying module being configured to spray fluid material on a surface, one or more actuators operatively coupled to the spraying module, at least a sensor for acquiring data indicative of altitude, wherein at least a controller located in at least one of the aerial platform and a control station is configured to control a position of the spraying module relatively to the aerial platform based on control signals generated during control cycles and applicable to the one or more actuators, the controlling comprising cyclically acquiring with said sensor data indicative of an altitude of a surface area in the flight path direction of the aerial platform, wherein said surface area is to be sprayed in a next control cycle, generating a control signal based on at least said acquired data, so as to maintain the altitude of the spraying module at a required distance of the altitude of the surface, and applying the generated control signal to the one or more actuators.

According to some examples, the sensor comprises at least an image sensor configured to take images of the surface area which is to be sprayed by the aerial platform during a next control cycle. According to some examples, the controller is further configured to compare the acquired data with pre-stored reference images of the surface, so as to detect obstacles in the surface. According to some examples, the controller is further configured to perform an analysis of the evolution of the acquired data, so as to detect obstacles in the surface. According to some examples, the controller is further configured to adapt a spraying period of the spraying module and/or a flight path of the aerial platform based on the detection of obstacles. According to some examples, a flight path of said aerial platform is controlled according to a flight path which is computed in advance based on pre-stored data on the altitude of surface. According to some examples, the controller is further configured to control inclination of the spraying module with respect to the aerial platform. According to some examples, the controller is further configured to control an inclination of the spraying module with respect to the aerial platform so as to maintain the spraying module substantially parallel to the surface. According to some examples, the controller is further configured to control an inclination and/or a position of the spraying module with respect to the aerial platform based on predictions of at least the attitude and/or the position of the aerial platform. According to some examples, the spraying module is connected to the aerial platform by at least a non-rigid connection. According to some examples, the controller is further configured to control the spraying module to reach a target position, and control an acceleration of a motion of the spraying module for reaching said target position. According to some examples, the controller is further configured to control a damping in the motion of the spraying module. According to some examples, the aerial platform further comprises at least a sensor for measuring a position and a velocity of the spraying module, wherein the controller is further configured to compute a control signal based at least on a damped combination of the measured position and velocity. According to some examples, the aerial platform further comprises at least a sensor for acquiring images of the surface from the aerial platform, wherein the controller is configured to identify particular portions of the surface in the images, and control the flight path of the aerial platform based on this identification. According to some examples, the controller is configured to control the flight path of the aerial platform based on this identification, even if an information on the current position of the aerial platform is not available. According to some examples, the particular portions include edges and/or borders of the surface. According to some examples, the aerial platform is an unmanned air vehicle (UAV). According to some examples, the aerial platform is a manned air vehicle. According to some examples, the aerial platform is an aerial platform remotely controlled by an operator.

In accordance with some aspects of the presently disclosed subject matter, there is provided an aerial platform comprising a spraying module being configured to spray fluid material on a surface, and one or more actuators operatively coupled to the spraying module by at least a non rigid connection, wherein at least a controller located in at least one of the aerial platform and a control station is a controller configured to control the spraying module so as to reach a position target relatively to the aerial platform, and generate a control signal for controlling at least an acceleration of the motion of the spraying module for reaching said position target.

According to some examples, the aerial platform comprises at least a sensor for measuring a position and a velocity of the spraying module, wherein the controller is configured to compute a control signal based at least on a damped combination of the measured position and velocity, for controlling the acceleration of the motion of the spraying module. According to some examples, the controller is configured to control a position of the spraying module relatively to the aerial platform based on control signals generated during control cycles and applicable to one or more actuators operatively coupled to the spraying module, the controlling comprising cyclically acquiring data indicative of an altitude of a surface area in the flight path direction of the aerial platform, wherein said surface area is to be sprayed in a next control cycle, generating a control signal based on at least said acquired data, so as to make the spraying module reach a position target which is at a required distance of the altitude of the surface, and applying the generated control signal to the one or more actuators. According to some examples, the aerial platform is an unmanned air vehicle (UAV). According to some examples, the aerial platform is a manned air vehicle. According to some examples, the aerial platform is an aerial platform remotely controlled by an operator.

In accordance with some aspects of the presently disclosed subject matter, there is provided a controller for controlling a spraying module of an aerial platform, the spraying module being configured to spray fluid material on a surface, the controller being configured to, during the flight of the aerial platform, control a position of the spraying module relatively to the aerial platform based on control signals generated during control cycles and applicable to one or more actuators operatively coupled to the spraying module, the controlling comprising cyclically acquiring data indicative of an altitude of a surface area in the flight path direction of the aerial platform, wherein said surface area is to be sprayed in a next control cycle, generating a control signal based on at least said acquired data, so as to maintain the altitude of the spraying module at a required distance of the altitude of the surface, and applying the generated control signal to the one or more actuators.

According to some examples, the spraying module is connected to the aerial platform by at least a non-rigid connection. According to some examples, the controller is configured to control the spraying module to reach a target position, and control an acceleration of a motion of the spraying module for reaching said target position. According to some examples, the controller is configured to control a damping in the motion of the spraying module. According to some examples, the controller is configured to receive a position and a velocity measurement of the spraying module, and compute a control signal based at least on a damped combination of the measured position and velocity.

In accordance with some aspects of the presently disclosed subject matter, there is provided a controller for controlling a spraying module of an aerial platform, the spraying module being loosely connected to the aerial platform and being configured to spray fluid material on a surface, the controller being configured to control the spraying module so as to reach a position target relatively to the aerial platform, and generate a control signal for controlling at least an acceleration of the motion of the spraying module for reaching said position target.

In accordance with some aspects of the presently disclosed subject matter, there is provided a non-transitory storage device readable by a machine, tangibly embodying a program of instructions executable by the machine to perform a method of controlling a spraying module of an aerial platform, the spraying module being configured to spray chemical products on a surface, the method comprising, during the flight of the aerial platform, controlling a position of the spraying module relatively to the aerial platform based on control signals generated during control cycles and applicable to one or more actuators operatively coupled to the spraying module, the controlling comprising cyclically acquiring data indicative of an altitude of a surface area in the flight path direction of the aerial platform, wherein said surface area is to be sprayed in a next control cycle, generating a control signal based on at least said acquired data, so as to maintain the altitude of the spraying module at a required distance of the altitude of the surface, and applying the generated control signal to the one or more actuators.

In accordance with some aspects of the presently disclosed subject matter, there is provided a non-transitory storage device readable by a machine, tangibly embodying a program of instructions executable by the machine to perform a method of controlling a spraying module of an aerial platform, the spraying module being configured to spray fluid material on a surface, the method comprising, during the flight of the aerial platform, controlling the spraying module so as to reach a position target relatively to the aerial platform, and controlling at least an acceleration of the motion of the spraying module for reaching said position target.

According to some examples, the solution provides a spraying method which takes into account predictions on the surface to be sprayed and/or on the flight plan of the aerial platform.

In particular, according to some examples, a control of a spraying module can be performed towards approaching peaks of the surface to be sprayed and/or obstacles, which thus allows a control in advance of the spraying module. In particular, this control can cope with the time response of the system.

According to some examples, night flying of the spraying aerial platform is allowed, which is advantageous since the weather is generally more stable at night.

According to some examples, the spraying module is connected to the aerial platform by at least a non-rigid connection which allows substantial distancing of the spraying module with respect to the aerial platform, and thus reduces turbulence (generated e.g. by the wings and/or engine) and increases safety of the flight. In addition, since the spraying module can be located at a certain distance from the aerial platform, and since non-rigid connection does not transfer the full impact acceleration to the aerial platform, a collision of the spraying module with an obstacle does not endanger the aerial platform.

According to some examples, a real time fine tuning of the position of the spraying module can be performed.

According to some examples, a pre-computed flight plan of the aerial platform is fine tuned in real time, together with the control of the position of the spraying module.

According to some examples, a real time detection of obstacles can be performed.

According to some examples, a real time weather analysis can be performed.

According to some examples, a quick folding of the spraying is possible, which allows protecting the spraying module from ground obstacles and the aerial platform.

A feature of at least one example of the presently disclosed subject matter is that the non-rigid supports allow for a range of spacings and/or spatial orientations between the manifold member and the support structure, and which can include such spacings that are significantly larger than the linear dimensions of the air vehicle that is carrying the spraying system. For example, such spacings can be multiples of the vertical dimension and/or the lateral dimension and/or the longitudinal dimension of the air vehicle. Such a spacing is theoretically limited by the length of the non-rigid support that can be carried by the air vehicle, for example via a spool which can thus carry a relatively large length of the non-rigid support in a compact manner. According to this feature, the manifold member can be supported by the support structure via the non-rigid supports providing higher quality aerial spraying (with the manifold member closer to the crops being dusted, for example), with minimal or no interference from the air vehicle or its propulsion system (which conventionally generate high turbulence and vortices close to the spraying nozzles by being close thereto).

Another feature of at least one example of the presently disclosed subject matter is that the non-rigid supports are not configured for supporting or transmitting compression loads during operation of the spraying system. Thus, in the event of a collision by the manifold member on the ground or on other obstacles (when the manifold member is spaced from the support structure), such a collision does not transfer the full force of the impact to the support structure or the air vehicle, in general terms, the more the manifold member is spaced from the support structure, the less the force of such an impact is transmitted to the support structure or to the air vehicle. This can be considered a safety feature for the spraying system and for the air vehicle.

Another feature of at least one example of the presently disclosed subject matter is that the non-rigid supports facilitate retracting of the spraying system to a stowed position, in particular of the manifold member with respect to the support structure, to avoid interfering with the operation of the undercarriage, and thus facilitate take-off and landing of the air vehicle.

Another feature of at least one example of the presently disclosed subject matter is that the non-rigid supports facilitate folding of the spraying system, in particular of the manifold member and of the support structure, to a folded or stowed configuration, which can be useful for take-off, landing or transportation of the air vehicle via a transport vehicle.

Another feature of at least one example of the presently disclosed subject matter is that the non-rigid supports can be configured as cables, having relatively low drag characteristics, and/or relatively high strength to weight ratio, as compared to conventional crop dusting solutions.

### BRIEF DESCRIPTION OF THE DRAWINGS

In order to better understand the subject matter that is disclosed herein and to exemplify how it may be carried out in practice, examples will now be described, by way of non-limiting example only, with reference to the accompanying drawings, in which:

FIG. 1 shows in isometric view an aerial spraying assembly according to a first example of the presently disclosed subject matter.

FIG. 2 shows in isometric view an air vehicle according to a first example of the presently disclosed subject matter.

FIG. 3 shows in isometric detail view part of the air vehicle of the example of FIG. 2 including the aerial spraying assembly of the example of FIG. 1.

FIGS. 4(a) to 4(d) show in isometric view the example of the air vehicle of FIG. 3, in which the aerial spraying assembly is in various stages of operation in which the manifold member is being moved away from the support structure in one degree of freedom in translation: FIG. 4(a) shows the manifold member partially deployed; FIG. 4(b) shows the manifold member further displaced from the support structure; FIG. 4(c) shows the manifold member even further displaced from the support structure; FIG. 4(d) shows the manifold member at maximum displacement from the support structure.

FIG. 5 shows in front view the example of the air vehicle of FIG. 3, in which the manifold member is spaced moved away from the support structure in one degree of freedom in translation, and spatially oriented in roll with respect to the support structure.

FIG. 6 shows in front view the example of the air vehicle of FIG. 3, in which the manifold member is spaced moved away from the support structure in one degree of freedom in translation, and spatially oriented in roll and pitch with respect to the support structure.

FIGS. 7(a), 7(b), 7(c), 7(d) show in isometric view, top view, front view and side view, respectively, the example of the air vehicle of FIG. 3 in compact configuration and circumscribed within an imaginary envelope.

FIGS. 8(a) to 8(c) show in isometric view the air vehicle of FIG. 3 with the aerial spraying assembly of FIG. 1 in compact configuration, in partially deployed configuration, and in fully deployed configuration (parked configuration), respectively.

FIG. 9 schematically illustrates an airborne spraying system according to a first example of the presently disclosed subject matter.

FIG. 10 is a block diagram of parts of an aerial platform according to aspects of the presently disclosed subject matter.

FIG. 11 illustrates a method of controlling the spraying module of a UAV according to an example of the presently disclosed subject matter.

FIG. 12 illustrates a simplified example in which at least data indicative of the altitude of a surface are to be sprayed in a next control cycle are collected

FIG. 13 illustrates examples of some of the input and output of a controller controlling the aerial platform.

FIG. 14 illustrates an example of a method of controlling the inclination of the spraying module with respect to a surface area to be sprayed in a next control cycle.

FIG. 15 illustrates an example of a method of detecting obstacles.

FIG. 16 illustrates examples for controlling the motion of the spraying module.

FIG. 17 illustrates a particular control loop for controlling the acceleration of the spraying module.

FIG. 18 illustrates an example of a method for controlling the position of the aerial platform.

### DETAILED DESCRIPTION

In the following detailed description, numerous specific details are set forth in order to provide a thorough understanding of the presently disclosed subject matter. However, it will be understood by those skilled in the art that the presently disclosed subject matter may be practiced without these specific details. In other instances, well-known methods have not been described in detail so as not to obscure the presently disclosed subject matter.

Unless specifically stated otherwise, as apparent from the following discussions, it is appreciated that throughout the specification discussions utilizing terms such as “feeding”, “reconstructing”, “replicating”, “updating”, “comparing”, “providing”, or the like, refer to the action(s) and/or process(es) of a processor that manipulate and/or transform data into other data, said data represented as physical, such as electronic, quantities and/or said data representing the physical objects.

The term “processing unit” covers any computing unit or electronic unit that may perform tasks based on instructions stored in a memory, such as a computer, a server, a chip, etc. It encompasses a single processor or multiple processors, which may be located in the same geographical zone or may, at least partially, be located in different zones and may be able to communicate together.

Examples of the presently disclosed subject matter are not described with reference to any particular programming language. It will be appreciated that a variety of programming languages may be used to implement the teachings of the presently disclosed subject matter as described herein.

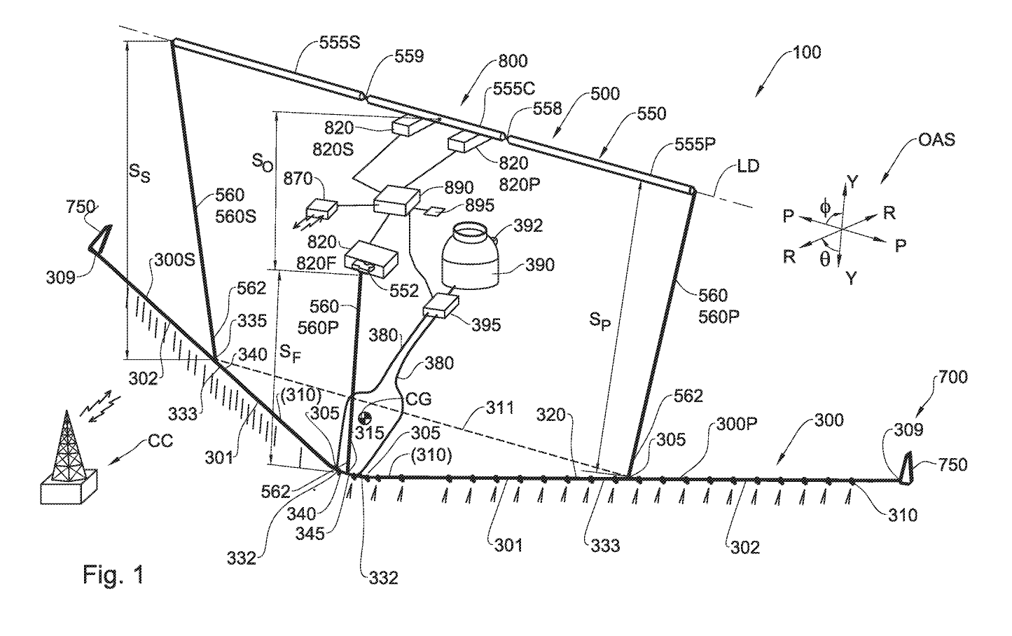

Referring to FIG. 1, an aerial spraying assembly for aerial spraying a ground surface, according to a first example of the presently disclosed subject matter, generally designated 100, comprises a manifold member 300 and a support structure 500.

Herein, “ground surface” or “surface” refers to a (real or imaginary) surface to be sprayed by the aerial spraying assembly, for example one or more of a real ground surface, or an imaginary surface defined by the upper parts of crops or trees that are to be sprayed, for example. The ground surface can thus includes various surfaces such as the ground and/or the tops of trees, crops, vines etc of a field, orchard, vineyard, forest, woods, and so on, and can comprise various elements to be aerially sprayed, for example crops, vegetables, trees, vines, etc. This list is not limiting.

The ground surface can have a constant height, or a variable height.

Obstacles can also be present on the ground surface, which do not need to be aerially sprayed. Such obstacles can include, for example, fixed elements such as houses, barns, parked vehicles, towers, etc, and/or movable elements such as moving vehicles, animals, humans, etc. This list is not limiting.

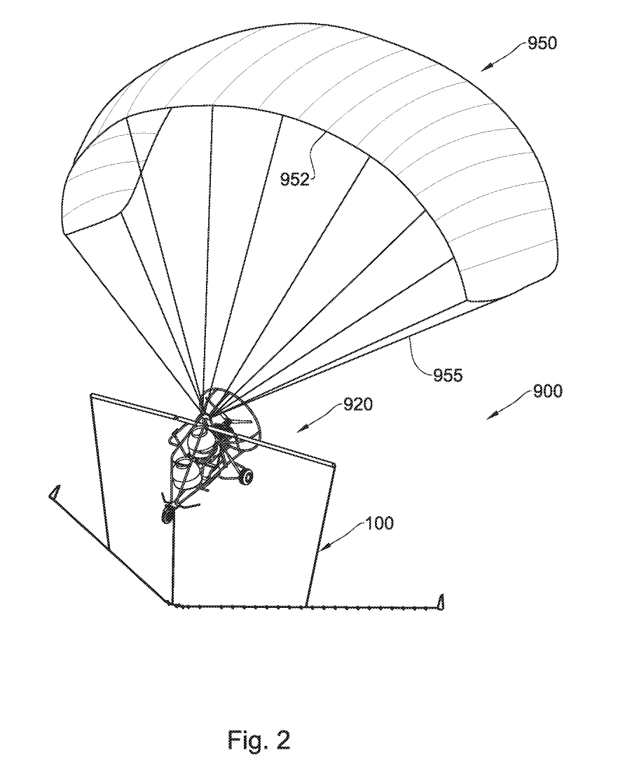

As will become clearer below, the aerial spraying assembly 100 is configured for use with an aerial platform, for example such as an air vehicle, for example air vehicle 900 illustrated in FIGS. 2 to 9 as discussed below, and the aerial spraying assembly 100 is thus mountable to the respective aerial platform and operatively connectable thereto.

The manifold member 300 comprises a plurality of spray nozzles 310 for enabling aerial spraying of a fluid material M therefrom during operative use of the aerial spraying assembly 100.

Herein, the term “fluid material”, also interchangeably referred to herein as a “fluid medium”, includes any suitable agents in liquid form, for example fertilizers, fungicides, herbicides, pesticides, or even water, or any required product that need to be sprayed on a surface, and/or any suitable agents in any suitable physical form, for example solid form (for example seeds, granular material or dust), and/or in gaseous, vapour, or aerosol form. This list is not limiting.

The manifold member 300 in this example comprises two separate manifold member portions—port manifold portion 300P and starboard manifold portion 300S. In this example each one of the port manifold portion 300P and starboard manifold portion 300S comprises a respective fluid inlet 305, a respective plurality of spray nozzles 310, and a respective lumen 310 providing fluid communication between the respective fluid inlet 305 and the respective spray nozzles 310.

In alternative variations of this example, the manifold member 300 can instead comprise more than two separate manifold member portions, or a single manifold member portion, and/or, each manifold member portion can include more than one fluid inlet and/or more than one lumen providing fluid communication between the respective fluid inlet(s) and the respective spray nozzles that are located on the respective manifold member portion.

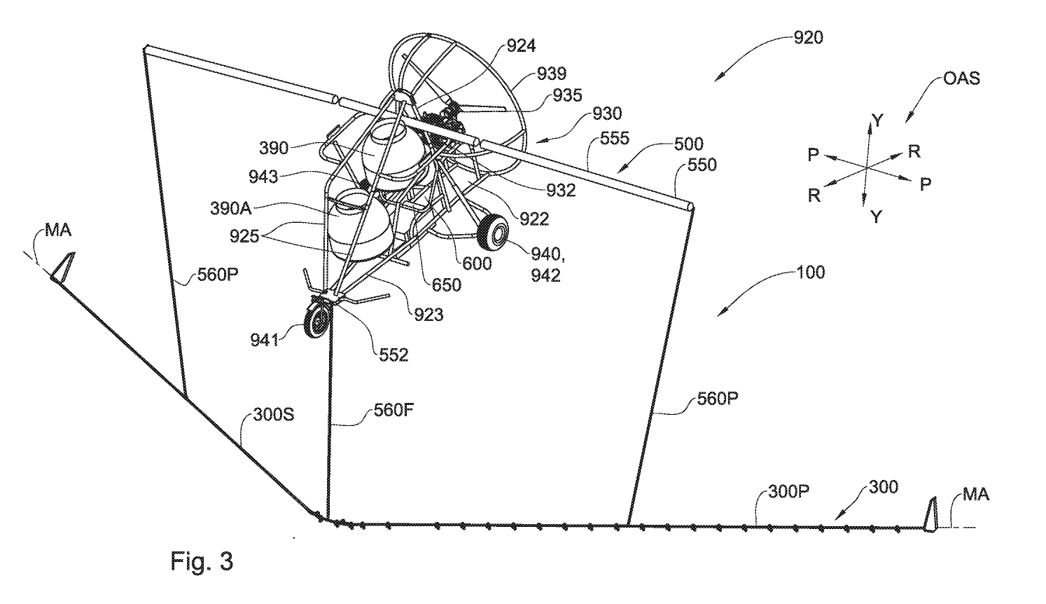

In this example, each one of the port manifold portion 300P and starboard manifold portion 300S of manifold member 300 is connected via a respective conduit 380 to a tank 390 (and is thus configured for being thus connected), which can be filled with the desired fluid material M via a filler cap 392. A second tank 390A (see FIG. 3), or indeed further additional tanks, can also be provided to increase the amount of fluid material M carried by the air vehicle and available for aerial spraying.

A suitable controllable valve system, comprising at least one suitable controllable valve 395, is operable to selectively open or close fluid communication between the tank 390 and the manifold member 300, to thereby respectively enable or prevent spraying of the fluid material M via the spray nozzles 310. When the control valve 395 is in the open position, fluid material M can flow from tank 390 to the manifold member 300, and out of the spray nozzles 310, by gravity. Alternatively, a suitable pump (not shown) can be provided for actively pumping fluid material M from tank 390 to the manifold member 300, and out of the spray nozzles 310 when the control valve 395 is in the open position.

In this example the controllable valve 395 is positioned in proximity to the tank 390 (or in proximity to the pump, if the pump is provided). Alternatively, the controllable valve 395 can be installed on the manifold member 300, and a power supply and a command line can be connected to the manifold member 300 to enable control and operation of the controllable valve 395.

In alternative variations of this example a wireless communication system can be provided to control the controllable valve 395, and a power source is provided for the controllable valve 395 on the manifold member 300. Such a power source can include, for example, one or more of: a battery, a RAT (Ram Air Turbine), solar panels and so on.

In alternative variations of this example, the suitable controllable valve system can comprise individual nozzle valves (not shown) provided for each nozzle 310, in addition the controllable valve 395, which acts as a central valve for controlling the flow of fluid material M to the entire manifold member 300, while selective control of each nozzle valve can provide more precise spraying control. For example, only some of the nozzles valves can be opened, leaving others closed. Alternatively, the nozzles can be operated according to a pulse width modulation (PWM) or duty cycle—for example one or more of the spray nozzles can be operated in pulses such that the mass flow rate of the material M sprayed by the spray nozzles over an extended period of time can be controlled. In yet other alternative variations of this example the individual nozzle valves can be provided for each nozzle 310, instead of the controllable valve 395; thus each nozzle valve directly controls the flow of fluid material M to the respective spray nozzle 310.

In alternative variations of this example, the manifold member 300, or each manifold portion, can instead be connected to a plurality of tanks, which can then selectively provide fluid material M to the manifold member 300, or to each respective manifold portion, for example in parallel or serially.

The port manifold portion 300P and starboard manifold portion 300S in this example are each in the form of a hollow spray bar, i.e., port bar 320 and a starboard bar 330, respectively, connected together via joint 340 at one respective end of each one to form a general V-configuration. The joint 340 is located at the apex 315 of the V-configuration and includes a mounting bracket 345 at an upper side thereof. The spray nozzles 310 are provided along an underside of each one the port bar 320 and the starboard bar 330 in suitable spaced relationship. In this example, the lumens 310 of the port bar 320 and the starboard bar 330 are not interconnected; however in alternative variations of this example, the lumens 310 of the port bar 320 and the starboard bar 330 are interconnected and in fluid communication with one another, for example via joint 340.

In alternative variations of this example, the joint 340 can also form part of the manifold member 300, and also include an internal lumen in selective fluid communication with the tank 390, and can comprise one or more spray nozzles.

In this example, the port manifold portion 300P and starboard manifold portion 300S are each elongate and rectilinear, each having a respective longitudinal manifold axis MA, which lie on a manifold plane PL. For convenience, spatial orientations of the manifold member 300 in pitch and/or roll can be described in terms of the corresponding spatial disposition of manifold plane PL with respect to the pitch axis PP (also referred to interchangeably here as the lateral axis) and/or roll axis RR (also referred to interchangeably here as the longitudinal axis).

In alternative variations of this example, the respective manifold member portions can be non-rectilinear, for example curved, and optionally do not lie on a plane. Nevertheless, it is still be possible to geometrically define a “manifold plane” for such examples, corresponding to manifold plane PL, that is illustrative of the spatial disposition of the manifold member with respect to at least the pitch axis PP and/or roll axis RR.

Each one of the port manifold portion 300P and starboard manifold portion 300S is provided with a mounting bracket 325, 335, respectively, at an upper side thereof.

To further facilitate comprehension, reference is made to orthogonal axes system OAS in FIG. 1, in which PP is the pitch axis of an aerial platform (onto which the aerial spraying system is to be mounted, for example such as an air vehicle, for example air vehicle 900 illustrated in FIGS. 2 to 9 as discussed below), RR is the roll axis of the aerial platform, and YY is the yaw axis of the aerial platform.

The support structure 500 includes a base structure 550 and a plurality of non-rigid supports 560 for selectively supporting the manifold member 300 in a spaced spatial relationship with respect to the base structure 550 via the non-rigid supports 560.

The base structure 550 is configured for being mountable to an aerial platform, for example such as an air vehicle, for example air vehicle 900 illustrated in FIGS. 2 to 9 as discussed below, and is thus mountable to the respective aerial platform and operatively connectable thereto.

The base structure 550 in this example comprises an aft base element 555 and a forward base element 552. The aft base element 555 in this example is in the form of an elongate load-supporting bar and having a longitudinal axis LD, which in operation of the system 100 is typically aligned in the port-starboard direction, i.e., parallel to the pitch axis PP of the air vehicle. The forward base element 552 is in the form of load supporting bracket, located along the longitudinal axis, or roll axis RR, also of the aerial spraying assembly 100. In this example, and particularly when installed in an air vehicle, for example air vehicle 900 (see FIGS. 2 to 9), the forward base element 552 is vertically spaced in a downward direction with respect to base element 555, by a spacing S₀. Thus, in the parked configuration, the manifold member 300 adopts a pitch down, zero roll, zero yaw, spatial orientation with respect to the support structure 500, and is at nominally zero spacing with respect thereto in the vertical direction.

In alternative variations of this example, the manifold member 300 can adopt any suitable spatial orientation and/or spacing with respect to the support structure 500 in the parked configuration—for example: a zero pitch or a pitch up spatial orientation, and/or a positive yaw or negative yaw spatial and a non-zero spacing in the vertical direction, with respect to the support structure 500.

Each non-rigid support 560 is in the form of load bearing cable or wire, capable of supporting a suitable load in tension but not in compression, and has a free longitudinal end 562 configured for being affixed to the manifold member 300, and a second longitudinal end 564 configured for being operatively coupled to actuation system 800, which will be referred to in more detail below. In particular, the plurality of non-rigid support 560 together are capable of supporting the weight of the manifold member 300 as well as their own weight, and also the weight of any fluid M present in the manifold member 300, as well as any dynamic loads induced thereon when airborne, for example Such dynamic loads can include for example, vertical acceleration loads of, say, up to 2.5 g, and/or horizontal accelerations, for example as induced when turning in yaw in a tight circle.

Such load bearing cable or wire can be in solid cross-section or can have one or more lumens therein, and the function of providing the fluid material M is executed via conduits 380, which in his example are different from the non-rigid support 560.

In alternative variations of this example, the function of the conduits 380 can be incorporated in one or more of the non-rigid support 560 (for example, in the illustrated example: the front non-rigid support 560F, and/or the port support 560P and/or the starboard support 560S—see below), which can be configured, for example, as flexible hoses (also referred to interchangeably herein as flexible pipes, or flexible tubes), capable of transmitting tensile loads between the manifold member 300 and the support structure 500, as well as selectively transferring the fluid material M from the tank to the manifold member 300. For example, such an integrated non-rigid support 560 can include a drum for compactly rolling the flexible hose via actuation of the respective actuator 820 (see below).

In this example, the support structure 500 comprises three non-rigid supports 560, referred to herein as the forward support 560F, the port support 560P and the starboard support 560S. The forward support 560F, the port support 560P and the starboard support 560S are affixed to the manifold member 300 at brackets 345, 325, 335, respectively, via the respective free longitudinal ends 562 of the forward support 560F, the port support 560P and the starboard support 560S, respectively.

Thus, the center of gravity CG of the manifold member 300 is enclosed within the triangle formed by the port manifold portion 300P, the starboard manifold portion 300S, and an imaginary line 311 connecting the brackets 325, 335. The position of the center of gravity CG within this triangle determines the distribution of loads between the various non-rigid supports 560. In this example, the position of the center of gravity CG remains within this triangle to ensure the static stability of the manifold member 300 when spaced from the support structure 500.

Actuation system 800 comprises three individually and independently actuable actuators 820F, 820P, 820S (collectively referred to as actuators 820), operatively coupled to the forward support 560F, the port support 560P and the starboard support 560S, respectively. In this example, each actuator 820 is in the form of a powered winch or drum, capable of selectively pulling in (wind up) and selectively letting out (wind out) the respective non-rigid support 560 to thereby adjust the vertical spacing and spatial orientation between the base structure 550 and the manifold member 300.

The vertical spacing between the base structure 550 and the manifold member 300 can be defined as the vertical spacing between the center of gravity CG and one of the aft base element 555 and the forward base element 552, or between the center of gravity CG and the mean vertical position between the aft base element 555 and the forward base element 552, for example.

The vertical spatial orientation between the base structure 550 and the manifold member 300 can be defined, for example, as the orientation of the manifold plane PL with respect to at least one of the roll axis RR and the pitch axis PP, and optionally also with respect to the yaw axis YY.

The individual vertical spacings S provided by each of the forward support 560F, the port support 560P and the starboard support 560S, are designated herein also as S_{F}, S_{P}, S_{S}, respectively.

Each respective vertical spacing S_{F}, S_{P}, S_{S} between the base structure 550 and the manifold member 300 can be individually and independently changed via the respective actuators 820F, 820P, 820S, to any desired value between a respective minimum spacing S_{MIN} and a respective maximum spacing S_{MAX}.

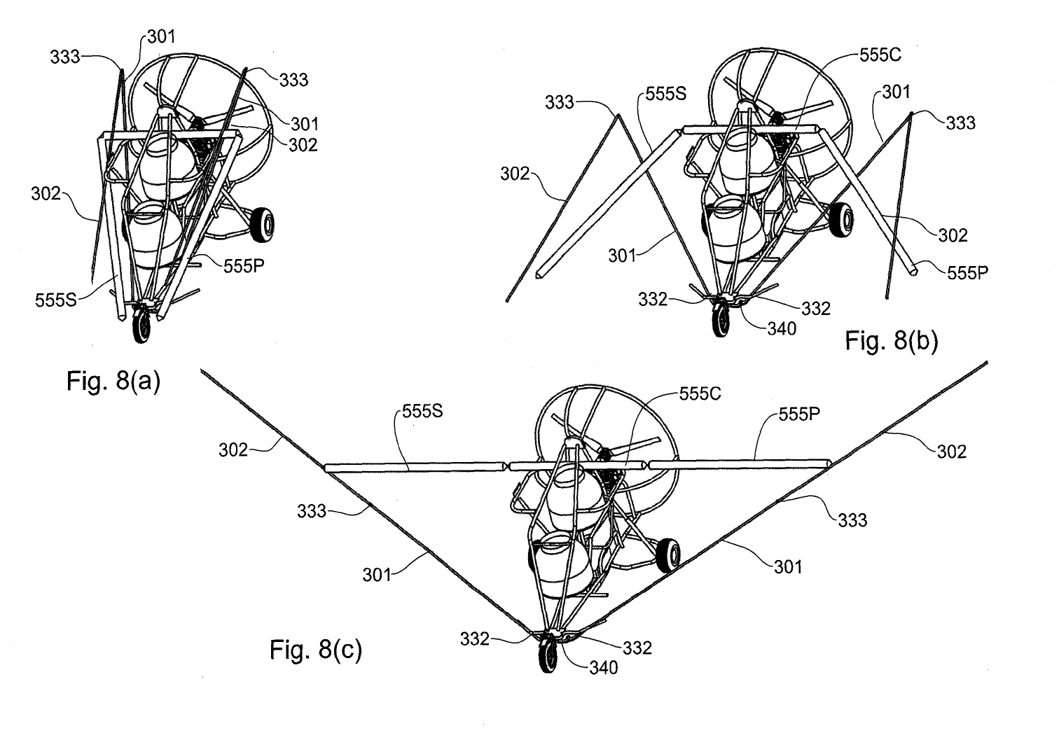

For example, at the respective minimum spacing S_{MIN} for the forward support 560F, the port support 560P and the starboard support 560S, the aerial spraying assembly 100 is in the parked configuration (see for example FIG. 8(c)), wherein there is nominally no freedom of movement, in either translation or rotation, between the manifold member 300 and the support structure 500. In the parked configuration the manifold member 300 and the support structure 500 are essentially locked with respect to one another. In the parked configuration, take-off and landing maneuvers for the air vehicle 900 are possible, and/or any one or more of ground handling, transport and storage of the air vehicle 900, and so on.

Operating the three actuators 820F, 820P, 820S to selectively change each of the vertical spacings S_{F}, S_{P}, S_{S} within the respective ranges of S_{MIN} to S_{MAX} provides at least one translational degree of freedom and at least one or two rotational degrees of freedom for the manifold member 300 with respect to the support structure 500.

For example, operating the three actuators 820F, 820P, 820S concurrently to provide the same change in each vertical spacing S_{F}, S_{P}, S_{S} results in the manifold member 300 being displaced vertically towards or away from the base structure 550, while conserving the same spatial orientation of the manifold member 300 with respect to the base structure 550. Thus, in this manner, the manifold member 300 is provided with one translational degree of freedom with respect to the base structure 550 in the vertical direction (aligned with gravity).

For example, operating the two aft actuators 820P, 820S concurrently so that each vertical spacing S_{P}, S_{S} changes by the same value, while operating the forward actuator 820F to concurrently provide a different change in spacing S_{F} than for spacings S_{P}, S_{S}, results in the manifold member 300 being spaced towards or away from the support structure 500, while concurrently providing a pitching rotation the manifold member 300 with respect to the base structure 550. For example if the change in the forward spacing S_{F} is greater than the change in the aft spacings S_{P}, S_{S}, this results in nose-up pitching of the manifold member 300 with respect to the base structure 550, and corresponding change in the spatial orientation, in particular the pitch angle θ, of the manifold member 300 with respect to the base structure 550 (for example, to provide a change in the pitch angle θ the manifold plane PL with respect to the orthogonal axes system OAS). Conversely, for example if the change in the forward spacing S_{F} is less than the change in the aft spacings S_{P}, S_{S}, this results in nose-down pitching of the manifold member 300 with respect to the base structure 550, and corresponding change in the spatial orientation, in particular the pitch angle θ, of the manifold member 300 with respect to the base structure 550 (for example, to provide a change in the pitch angle θ the manifold plane PL with respect to the orthogonal axes system OAS). Thus, in this manner, the manifold member 300 is provided with one rotational degree of freedom with respect to the base structure 550 in pitch, i.e., about the pitch axis PP.

For example, operating the two aft actuators 820P, 820S differentially so that each vertical spacing S_{P}, S_{S} changes by the a different value, while operating the forward actuator 820F to concurrently provide a different change in spacing S_{F} (for example corresponding to the average change in the spacings S_{P}, S_{S}) results in the manifold member 300 being spaced from the base structure 550, while concurrently providing a rolling rotation the manifold member 300 with respect to the base structure 550. For example, if the change in the starboard spacing S_{S} is greater than the change in the port spacing S_{P}, this results in rolling of the manifold member 300 with respect to the base structure 550 in one direction, and corresponding change in the spatial orientation, in particular the roll angle ϕ, of the manifold member 300 with respect to the base structure 550 (for example, to provide a change in the roll angle ϕ the manifold plane PL with respect to the orthogonal axes system OAS). Conversely, for example, if the change in the starboard spacing S_{S} is less than the change in the port spacing S_{P}, this results in rolling of the manifold member 300 with respect to the base structure 550 in the opposite direction, and corresponding change in the spatial orientation, in particular the roll angle ϕ, of the manifold member 300 with respect to the base structure 550 (for example, to provide a change in the roll angle ϕ the manifold plane PL with respect to the orthogonal axes system OAS). Thus, in this manner, the manifold member 300 is provided with one rotational degree of freedom with respect to the base structure 550 in roll, i.e., about the roll axis RR.

This rotational degree of freedom in roll can be used for a variety of maneuvers. For example, the rotational degree of freedom in roll can be used for providing a desired roll angle to the manifold member 300 while flying the air vehicle along a level course, i.e., where the air vehicle itself is not rolled, for example when aerial spraying a sloped surface for example of a hill. Alternatively, the rotational degree of freedom in roll can be used to maintain a desired and nominally uniform spacing between the boom member 300 and the surface being sprayed, while the air vehicle itself is being rolled, for example. Alternatively, the rotational degree of freedom in roll can be used to combine both such maneuvers.

It is also to be noted that, once the boom member 300 is deployed, it is generally only necessary to actuate one of the two aft actuators 820P, 820S to provide a roll maneuver of the boom member 300 with respect to the air vehicle and/or with respect to the surface being sprayed. For example, with the port actuator 820P being actuated to provide an up or down change in the port spacing S_{P} while maintaining the starboard spacing S_{S} unchanged results in a clockwise or counterclockwise roll, respectively, of the boom member 300. Thus, the provision of enabling the two aft actuators 820P, 820S to be operated independently of one another allows for some redundancy in operation of the actuation system 800, and allows for operation of the actuation system 800 at least in yaw even when one of the two aft actuators 820P, 820S is inoperative.

In alternative variations of this example, an active yaw system (for example including aerodynamic devices (for example controllable rudder) and/or mini-propulsion units) can be provided to the manifold member 300 to provide controllable freedom of movement in yaw to the manifold member 300.

By combining the above actuations of the three actuators 820F, 820P, 820S it is possible to provide any desired combination of pitch angle and/or roll angle and/or vertical displacement of the manifold member 300 with respect to the base structure 550 (for example, to provide a change in the pitch angle θ and/or the roll angle ϕ of the manifold plane PL with respect to the orthogonal axes system OAS), limited by the respective minimum values S_{MIN} and the respective maximum value S_{MAX} of each one of spacings S_{F}, S_{P}, S_{S}, thereby providing a desired change in the pitch angle θ and/or the roll angle ϕ of the manifold plane PL with respect to the air vehicle and or with respect to the ground surface that it is desired to spray.

In at least this example, the aerial spraying assembly 100 further comprises a manifold member stabilizing system 700, for providing a degree of stability of the manifold member 300 at least when in flight mode and the manifold member 300 is suspended from the base structure 550 via the plurality of non-rigid supports 560. In particular, such stability is provided in yaw, and for damping possible oscillations of the manifold member 300 with respect to the base structure 550, particularly in yaw. In this example, the stabilizing system 700 operates aerodynamically to provide aerodynamically induces loads to the manifold member 300 to provide yaw stability. In particular, the stabilizing system 700 is in the form of vertical stabilizers or winglets 750, provided at each one of the outboard ends, also referred to herein as the free ends 309, of the port manifold portion 300P and starboard manifold portion 300S. In this example the winglets 750 are designed with symmetrical non-cambered aerofoils, and are arranged with their zero-lift axes parallel to the roll axis RR, and with zero anhedral/dihedral with respect to the manifold plane PL. However, in alternative variations of this example, the winglets can be designed with non-symmetrical and/or cambered aerofoils, and/or can be arranged with their zero-lift axes non-parallel to the roll axis RR, and/or can be provided with non-zero anhedral or non-zero dihedral with respect to manifold plane PL. Furthermore, in other alternative variations of this example, the winglets can be replaced with suitable end plates of any suitable shape and size.

In yet other alternative variations of this example, the winglets can each be provided with an active rudder, controlled by suitable servo actuators and active control system to generate yaw control moments, and thus provide yaw stability and/or yaw control.

In yet other alternative variations of this example, the manifold member 300 can be designed to be aerodynamically self-stabilizing at least in yaw, wherein to generate yaw control moments, to provide yaw stability. For example, such a design can compel the manifold member 300 to follow the heading of the support structure 500 at all times, and any change in the heading of the support structure 500 induces aerodynamic forces on the manifold member 300 to align the same along the same heading as the support structure 500.

In yet other alternative variations of this example, the winglets can be replaced with thrust generating devices and/or drag generating devices to generate thrust or drag forces and thus control moments, to provide yaw stability.

The aerial spraying assembly 100 further comprises a controller 890, for example in the form of a microprocessing computer, operatively connected to the actuator system 800 and to the controllable valve 395.

The controller 890 is operable on at least a processing unit, and can communicate with at least a memory 895.

As will become clearer below, the controller 890 is configured for selectively operating the actuator system 800 to provide desired respective spacings S for each one of the forward support 560F, the port support 560P and the starboard support 560P to thereby provide a desired spacing and/or spatial orientation (in particular a desired pitch angle and/or a desired roll angle) between the manifold member 300 and base structure 550, as the air vehicle 900 is flown along a desired flight path.

Also as will become clearer below, the controller 890 is further configured for selectively operating the controllable valve system, for example the controllable valve 395, to allow spraying of medium M over a desired ground zone GZ as the air vehicle 900 is flown along a desired flight path over this ground zone GZ, using all or part of the manifold member 300. For example, in variations of this example, in which the controllable valve system can selectively provide fluid communication between the tank and each of the each one of the port manifold portion 300P and the starboard manifold portion 300S, independently of one another, it is possible to allow spraying of medium M over the desired ground zone GZ, using only one of the port manifold portion 300P and the starboard manifold portion 300S, or using both.

For example, the controller 890 can be preprogrammed to autonomously spray the material M while the air vehicle 900 is flown along a desired flight path over the ground zone GZ or part thereof.

In this example, the controller 890 is further operatively coupled to a communications module 870, configured for at least receiving control and command signals from a central control CC. in at least some examples, the communications module 870 is further configured for transmitting data to the central control CC, for example data relating to the operation of the aerial system 100 (for example amount of fluid M remaining in the tank, 390, possible malfunction of the actuation system 800 or valve 395, and so on).

The central control CC can include any suitable manual or automated controller that is configured for controlling the operation of one or more air vehicles (for example air vehicle 900) which include a respective aerial spraying assembly 100.

In this example, the aerial spraying assembly 100 further suitable sensors, for example one or more of the sensors 600 referred to below with reference to FIG. 3.

Referring to FIGS. 2 and 3 in particular, an aerial platform for aerial spraying, according to a first example of the presently disclosed subject matter, generally designated 900, is in the form of an air vehicle, in particular an ultralight aircraft, configured for mounting thereto an aerial spraying assembly, in particular the aerial spraying assembly 100, disclosed above with reference to FIG. 1. The air vehicle 900 in this example comprises an airframe 920 and wing 950.

Referring in particular to FIG. 3, the airframe 920 is in the form of an open space frame cart, comprising a plurality of struts 922 mutually connected to one another in load-bearing arrangement. In this example, the airframe 920 comprises a bottom horizontal A-frame 923, connected to an aft vertical A-frame 924, and upper longitudinal struts 925 interconnecting the apices of the A-frames 923, 924. Additional cross-struts are provided for cross-bracing the A-frames 923, 924 and struts 925.

The air vehicle 900 further comprises a propulsion unit 930, which in this example is in the form of an internal combustion engine 932 coupled to a pusher propeller 935, and mounted to an aft end of the airframe 920. In alternative variations of this example, more than one, and/or different types of propulsion units can be provided.

The airframe 920 further accommodates a fuel tank 938, which is operatively coupled to the propulsion unit 930 via a fuel line (not shown). A cage 939 is provided aft of vertical A-frame 924 for at least partially enclosing the propeller 935.

A suitable landing gear 940 is provided to the airframe 920, in this example in the form of a tricycle landing gear having a steerable front wheel 941, and aft thereof a port wheel 942 and a starboard wheel 943.

Referring again to FIG. 2, the wing 950 is configured for providing lift, stability and control to the air vehicle 900 in flight mode. In this example, the wing 950 is configured as a paraglider wing or canopy, otherwise known as a ram-air aerofoil, and comprises two layers of fabric separated by internal supporting webs to form a plurality of cells that are open only at the leading edge 952. Thus, when in flight mode, the cells inflate by the incoming ram air, the wing 950 adopts an aerofoil cross-section, as is well known in the art.

In flight mode the airframe 920 is supported underneath the wing 950 by a network of suspension lines 955, as is well known in the art.

Suitable actuators (not shown) are provided and coupled to the network of suspension lines 955, to selectively apply tension to one or more such lines 955, and thereby control maneuvering of the air vehicle 900. Such actuators are operatively coupled to the flight computer of the air vehicle 900.

In alternative variations of this example, the paraglider wing or canopy can be replaced with a powered parachute, for example.

The aerial spraying assembly 100 is mounted to the airframe 920 by connecting the aft base element 555 to the aft vertical A-frame 924, and the forward base element 552 to the apex of the bottom horizontal A-frame 923. The aft base element 555 in this example is thus mounted to the airframe 920 with its longitudinal axis LD parallel to the pitch axis PP. The forward base element 552 is mounted to the airframe 920 centrally.

In operation of the air vehicle 900 for aerial spraying, the air vehicle 900 takes off with the aerial spraying assembly 100 in parked configuration, as illustrated in FIG. 8(c). Initially, the wing 950 is draped on the ground and aft of the airframe 920, and initial inflation of the wing 950 is provided by the airstream from the propeller. As relative speed is induced between the wing 950 and the air around it, for example by placing the air vehicle 900 onto incoming wind and/or by allowing the air vehicle 900 to gain ground speed, the wing 950 becomes fully inflated and develops lift, thereby lifting the air vehicle 900, which then begins its flight mode.

The air vehicle can then be flown to a desired ground zone GZ, and can then be controlled to follow a desired flight path over ground zone GZ or a portion thereof for spraying the ground zone GZ with the medium M in a desired manner.

Such aerial spraying is accomplished via the aerial spraying assembly 100, and initially includes the step of deploying the manifold member 300 by suspending this from the base structure 550 from the parked configuration via the non-rigid supports 560F, 560P, 560S, using the actuation system 800, to provide desired changes in each vertical spacing S_{F}, S_{P}, S_{S}, and thus provide a desired spatial disposition of the manifold member 300 with respect to the base structure 550 (and thus with respect to the airframe 920, and thus with respect to the air vehicle 900) in terms of one or more of: vertical displacement, roll orientation and pitch orientation.

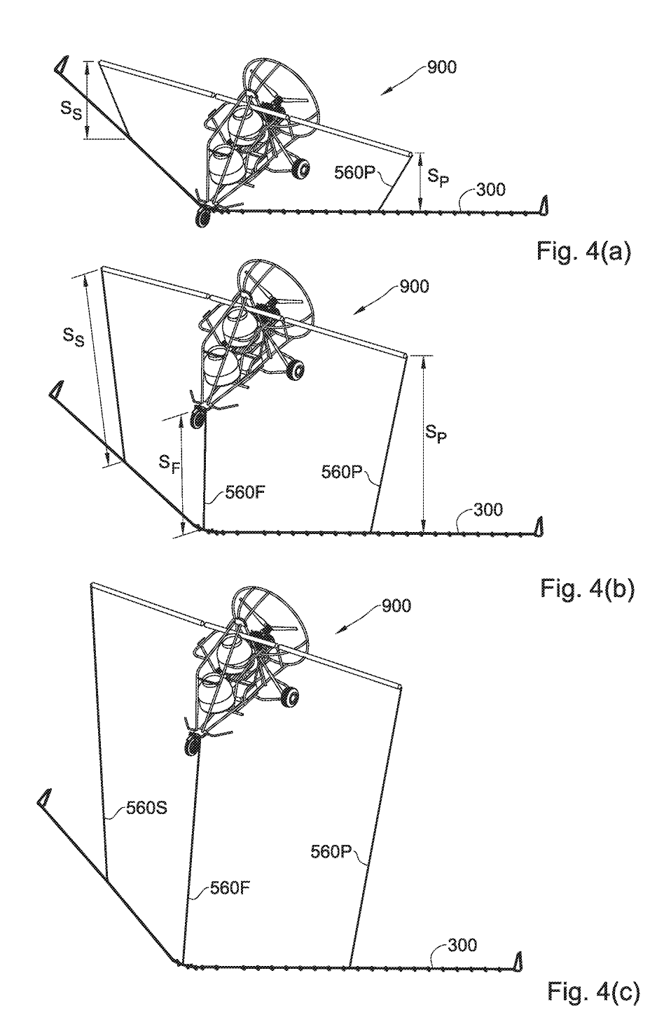

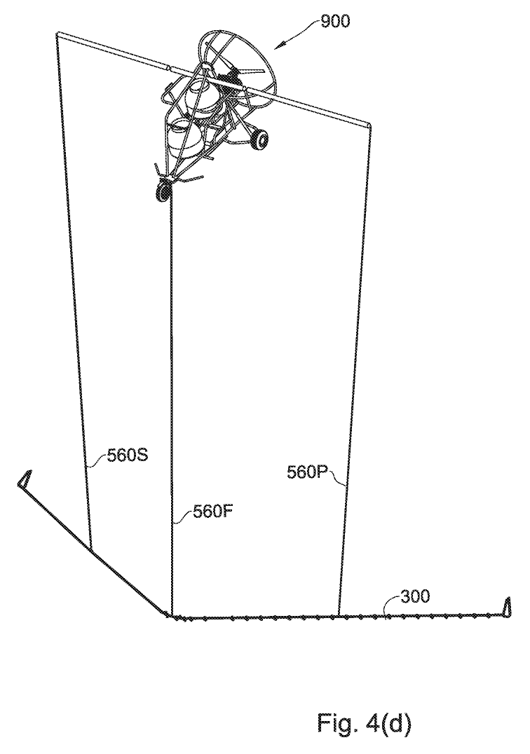

FIGS. 4(a) to 4(d) illustrate various changes in the spatial disposition of the manifold member 300 with respect to the base structure 550 (and thus with respect to the airframe 920, and thus with respect to the air vehicle 900) in terms of vertical displacement, while the corresponding roll orientation and pitch orientation are conserved.

In FIG. 4(a), the front vertical spacing S_{F} is at the corresponding minimum spacing S_{MIN}, while the port spacing S_{P} and the starboard spacing S_{S} are substantially the same, providing zero roll angle, and a desired pitch angle of zero to the manifold plane PL. Thereafter, the actuation system 800 is operated to provide equal additional changes in the vertical spacing S_{F}, S_{P}, S_{S}, thereby ensuring the spatial orientation of the manifold member 300 is unchanged, while changing the vertical spacing between the manifold member 300 and the air vehicle 900 while suspended therefrom. Thus, FIGS. 4(b) and 4(c) illustrate intermediate spacings for the manifold member 300 with respect to the air vehicle 900, while FIG. 4(d) illustrates a maximum spacing for the manifold member 300 with respect to the air vehicle 900. For example, this enables the air vehicle to fly straight and level over a ground surface (or crop upper surface) that is undulating, and maintain a constant vertical spacing between the spray nozzles 310 and the surface, using the spacing illustrated in FIG. 4(b) or 4(c), for example.

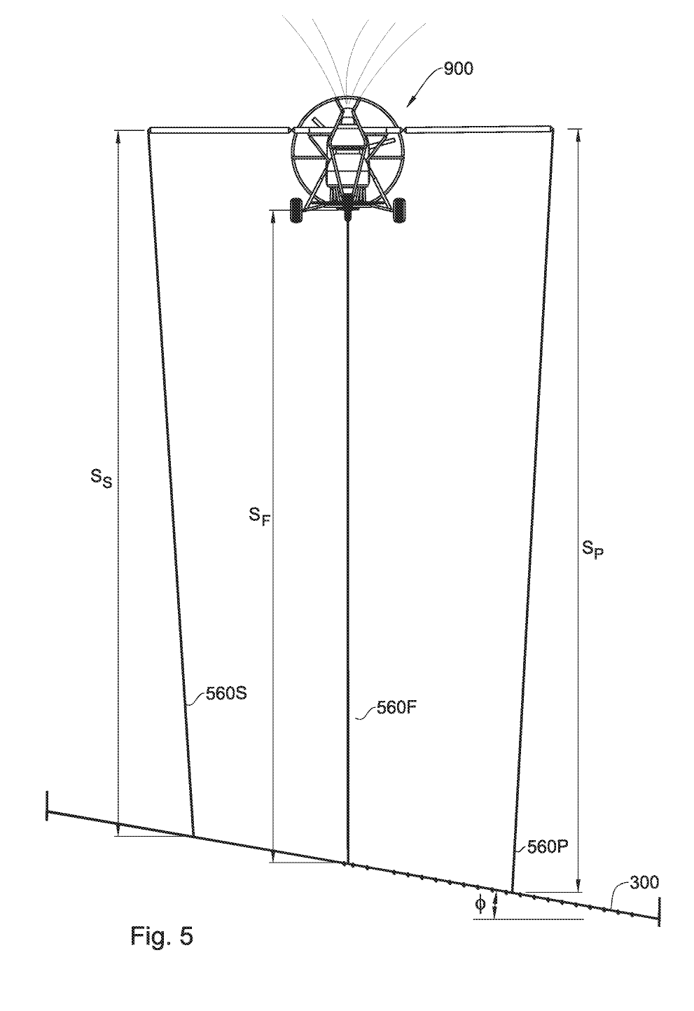

FIG. 5 shows a mean vertical spacing of the manifold member 300 relative to the air vehicle 900 similar to that of FIG. 4(d). However, in FIG. 5, the actuation system 800 is operated to provide desired changes in each vertical spacing S_{F}, S_{P}, S_{S}, such that the manifold member 300 also has a roll orientation (roll angle ϕ) but zero pitch orientation with respect to the base structure 550 (and thus with respect to the airframe 920, and thus with respect to the air vehicle 900).

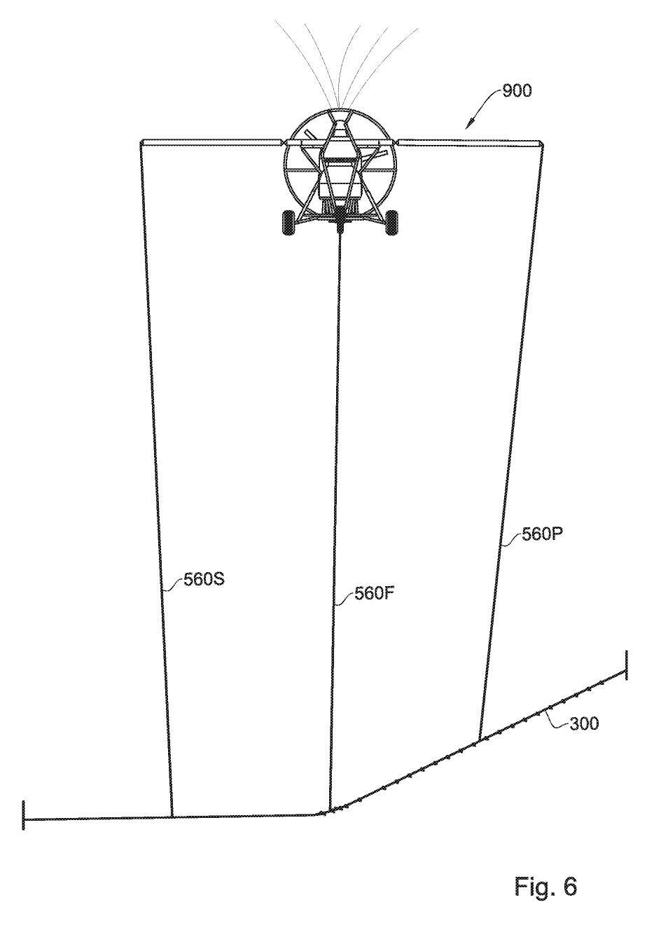

FIG. 6 shows a mean vertical spacing of the manifold member 300 relative to the air vehicle 900 similar to that of FIG. 5. However, in FIG. 6, the actuation system 800 is operated to provide desired changes in each vertical spacing S_{F}, S_{P}, S_{S}, such that the manifold member 300 also has a non-zero roll orientation and a non-zero nose down pitch orientation with respect to the base structure 550 (and thus with respect to the airframe 920, and thus with respect to the air vehicle 900).

It is to be noted that the orientation and/or vertical spacing of the manifold member 300 with respect to the ground surface (that it is desired to spray using the aerial spraying assembly 100) can be maintained essentially constant as the air vehicle 900 is flown over the ground surface, irrespective of the topography of the ground surface (for example non-flat surface, including hills, or other surface features), and also irrespective of the attitude and altitude of the air vehicle in three-dimensional space, i.e. with respect to the ground surface (as limited by the respective minimum values S_{MIN} and the respective maximum value S_{MAX} of each one of spacings S_{F}, S_{P}, S_{S}).

In other words, within limits, the flight path of the air vehicle 900 and the flight path of the manifold member 300, while interconnected, are not required to be identical, and the variable relative spatial dispositions between the manifold member 300 and the air vehicle 900 allows the flight path of the air vehicle 900 with respect to a ground zone GZ to be optimized, while enabling operating the aerial spraying assembly 100 to provide the desired manifold member to surface orientation and spacing at each point in the flight path of the air vehicle, regardless of the type of topography to be found at the ground zone GZ, which in turn can optimize the spraying of the fluid medium M to cover the desired surface. For example, the air vehicle is flown along a flight path in straight and level flight over non-flat terrain, and in which the aerial spraying assembly 100 operates to displace and orient the manifold member 300 to maintain a constant spacing and orientation with respect to, and thus match, the ground surface that the air vehicle is overflying. In another example, the air vehicle is flown along an undulating flight path that overlaps the ground zone, and the aerial spraying assembly 100 operates to displace and orient the manifold member 300 to maintain a constant spacing and orientation with respect to, and thus match, the ground surface that the air vehicle is overflying, taking into account the maneuvering of the air vehicle with respect to the ground surface.

Examples of operation of the air vehicle 900 and aerial system 100 will be provided below in greater detail.

In this example, the air vehicle 900 is configured as an unmanned air vehicle (UAV), remotely controlled by a human operator and/or via a suitable computer system at the central control CC. Furthermore, in this example the air vehicle 900 is further configured for being flown at least partially in autonomous mode. Thus, and referring again to FIG. 3, the air vehicle 900 further comprises suitable sensors 600 and a flight computer 650. For example, such sensors 600 can include one or more of the following sensors:
one or more ground surface sensors (which can be embedded in the air vehicle) for providing surface data indicative of the three dimensional topography of the ground surface over which the air vehicle is flying and optionally ahead to enable prediction, and/or looking forward to detect obstacles. For example, known sensors such image sensors, radar sensors, LIDAR sensors, acoustic sensors can be used in at least some examples. For example, such one or more ground sensors can be configured for providing surface data in real time. According to at least some examples, the air vehicle can store a ground surface 3D map in a database of a memory (such as a flash drive for example) and use a positioning system to locate itself in the database and extract the relevant surface data therefrom.
one or more vehicle inertial sensors for providing inertial data for the air vehicle, for example inertial data indicative of the position, orientation, altitude (with respect to sea level), height above ground, and flying direction of the air vehicle in three dimensional space, i.e., the Earth. For example, known sensors such as inertial sensors, GNSS sensors, GPS sensors, AHRS sensors, etc. can be used in at least some examples. For example, such one or more inertial sensors can be configured for providing inertial data in real time.
one or more manifold inertial sensors for providing inertial data for the manifold member, for example inertial data indicative of the position, orientation, altitude (with respect to sea level), height above ground, and flying direction of the manifold member with respect to air vehicle and/or with respect or the ground surface, for example. For example, known sensors such as inertial sensors, GNSS sensors, GPS sensors, etc. can be used in at least some examples. For example, such one or more manifold inertial sensors can be configured for providing inertial data in real time. For example, the length of the non-rigid supports 560 (for example via the rotational position of the actuators 820) can be determined by any one of a variety of sensors—for example potentiometers, optic encodes, magnetic encoders, and so on—which in turn provides the relative orientation and spacing between the manifold member 300 and the air vehicle. Thus, once the relative position and orientation of the air vehicle is known with respect to the ground surface, the spacing and orientation of the manifold member 300 with respect to the ground surface can be determined.

As will become clearer below, the sensors 600 facilitate operation of the air vehicle 900, and in particular the aerial spraying assembly 100, for aerial spraying a ground zone GZ or part thereof.

The flight computer 650 is operatively coupled to the air vehicle sensors, and also to the controller 890 of the aerial spraying assembly 100.

The flight computer 650 in this example controls the functions of the air vehicle 900, in particular to ensure that it follows the desired flight path, as well as controlling take-off and landing of the air vehicle 900.

In alternative variations of this example, the flight computer 650 incorporates the functions of controller 890, and thus is integral therewith.

In alternative variations of this example, the air vehicle can instead be in the form of any suitable fixed wing air vehicle or any suitable rotary wing air vehicle, either of which can be a manned air vehicle, or an unmanned air vehicle (UAV).

The air vehicle 900 in at least this example is further configured for adopting a compact configuration when not in flying mode, for example during transport or storage. For this purpose, the aerial spraying assembly 100 in this example is correspondingly configured for selectively adopting a corresponding compact configuration.

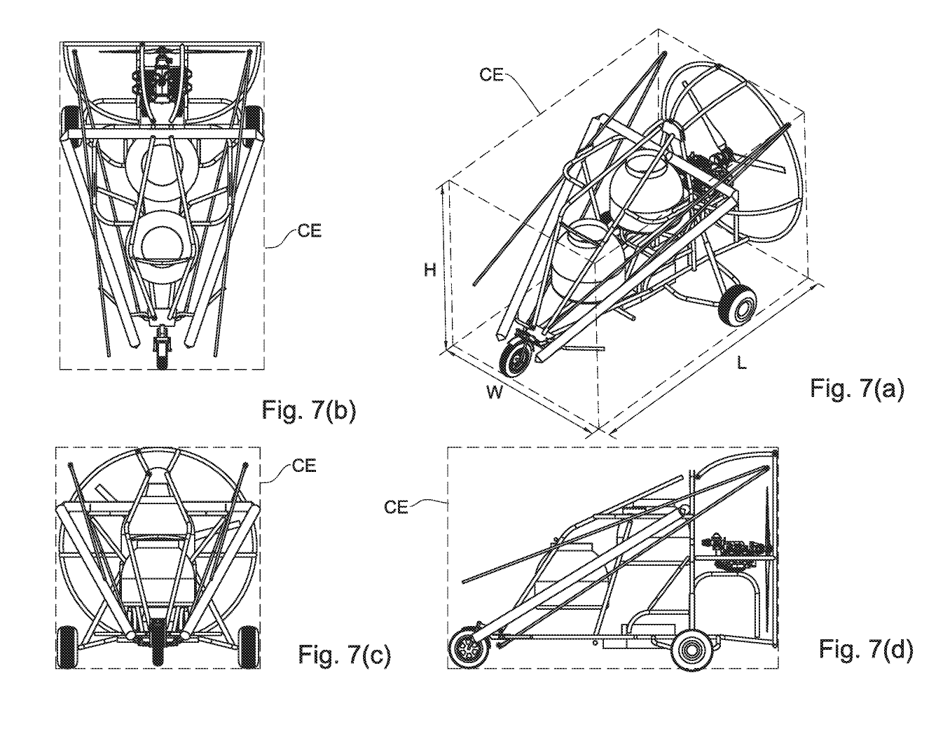

Referring to FIGS. 7(a) to 7(d), and in at least this example, the aerial spraying assembly 100 in its corresponding compact configuration, and when mounted to the air vehicle 900, generally fits within an imaginary envelope CE circumscribing the air vehicle 900. In this example, and for convenience, the imaginary envelope CE is a rectangular cuboid imaginary envelope.

For example, this imaginary rectangular cuboid envelope CE has a length dimension L, a width dimension W, and a height dimension H, corresponding to the maximum length, width and height of the air vehicle 900 when not in flight mode, i.e., excluding the wing and lines thereof which are typically outside of envelope CE during flight mode.

In this example, the length dimension L is about 3.5 m, the width dimension W is about 2.5 m, and the height dimension H is about 2.5 m.

To fit in this imaginary envelope CE, the manifold member 300 and at least part of the base structure 550, in particular the aft base element 555, are each formed as articulated members.

Referring again to FIG. 1, in this example the aft base element 555 is formed in three serially articulated sections: port base element 555P, central base element 555C, and starboard base element 555S. The central base element 555C is configured for being connected to the airframe 920. Suitable pivoting joints 558, 559 are provided between the port base element 555P and the central base element 555C, and between the base element 555C and the starboard base element 555S, respectively. In this example, pivoting joints 558, 559 each allow pivoting about one pivoting axis, though in alternative variations of this example, the pivoting joints 558, 559 can be configured to each allow pivoting about two orthogonal pivoting axes—for example in the form of universal joints.

Referring to the manifold member 300, each one of the port manifold portion 300P and the starboard manifold portion 300S is pivotably mounted to the joint 340 via respective pivoting joints 332. Furthermore, each one of the port manifold portion 300P and the starboard manifold portion 300S is formed in two serially articulated sections, including a respective front manifold section 301 and a respective aft manifold section 302, pivotably joined to one another via respective suitable pivoting joints 333. In this example, each one of the respective pair of pivoting joints 332, 332 allow pivoting about one pivoting axis, though in alternative variations of this example, each one of the respective pair of pivoting joints 332, 332 can be configured to each allow pivoting about two orthogonal pivoting axes—for example in the form of universal joints.

Referring to FIGS. 8(a) to 8(c), in the compact configuration illustrated in FIG. 8(a) (and also shown in FIGS. 7(a) to 7(d)) the articulated aft base element 555 adopts an undeployed configuration, in which the port base element 555P and starboard base element 555S are each pivoted away from axial alignment with central base element 555C, via pivoting joints 558, 559, to provide a U-shaped or triangular configuration. Concurrently, the articulated manifold member 300 adopts an undeployed configuration, in which for each one of the port manifold portion 300P and the starboard manifold portion 300S, the respective front manifold section 301 is pivoted away from axial alignment with the respective aft manifold section 302. Furthermore, the thus-folded port manifold portion 300P and starboard manifold portion 300S are also pivoted towards one another via respective pivoting joints 332, thereby adopting a W-like shape, as best seen in FIG. 8(b).

In the parked configuration illustrated in FIG. 8(c), the articulated aft base element 555 adopts a deployed configuration, in which the port base element 555P, starboard base element 555S and central base element 555C are in axial alignment. Concurrently, the articulated manifold member 300 adopts a deployed configuration, in which for each one of the port manifold portion 300P and the starboard manifold portion 300S, the respective front manifold section 301 is pivoted to provide axial alignment with the respective aft manifold section 302, and the port manifold portion 300P and starboard manifold portion 300S are also pivoted away from one another via respective pivoting joints 332, thereby adopting a V-like shape, as best seen in FIG. 8(c).

A suitable locking mechanism (not shown) can be provided for locking the articulated manifold member 300 in the deployed configuration, and for locking the articulated aft base element 555 in the deployed configuration.

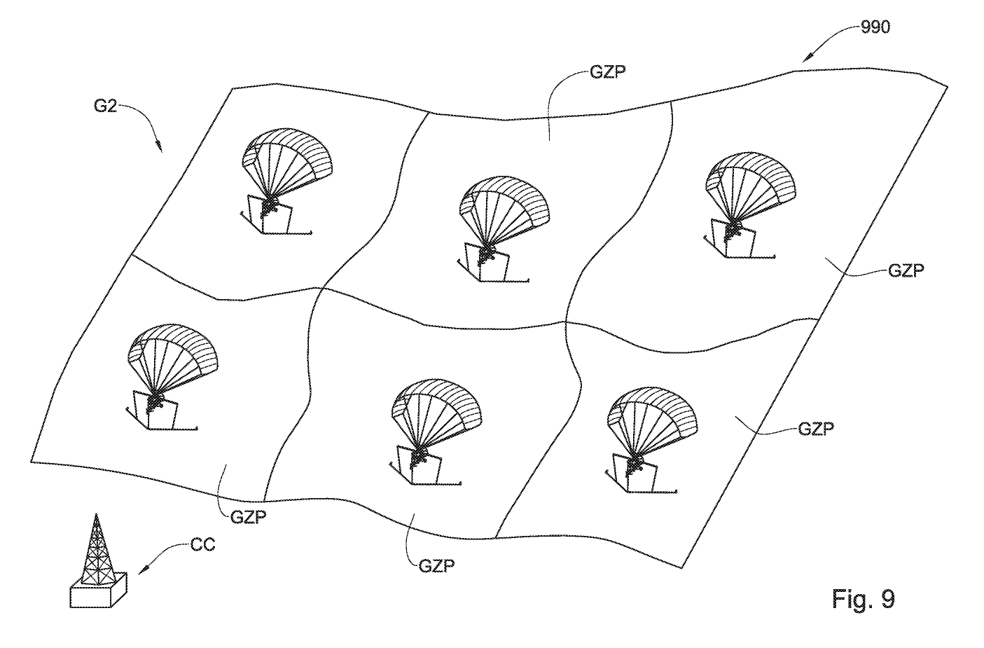

According to another aspect of the presently disclosed subject matter, and referring to FIG. 9, a plurality of air vehicles, for example a plurality of air vehicles 900, in particular in the form of UAV's, are provided, and controlled from the central control CC to provide an airborne spraying system, generally designated 990. The airborne spraying system 990 can further comprise a plurality of ground transport, for transporting the air vehicles 900, particularly when in their compact configuration illustrated in FIGS. 7(a) to 7(d). The airborne spraying system 990 is configured for operating each one of the air vehicles 900 autonomously to spray a different portion GZP of the desired ground zone GZ, such that together the plurality of air vehicles 900 covers the entire desired ground zone GZ. The central control CC can control the plurality of air vehicles 900 and/or monitors the operation of the plurality of air vehicles 900. Additionally or alternatively, the central control CC can load the mission plans to each one of the plurality of air vehicles 900 (while on the ground or when airborne), and for this purpose the central control CC does not need to be in constant communication with the plurality of air vehicles 900 once the loading is completed. While in the above example illustrated in FIGS. 1 to 3 the aerial spraying assembly comprises three non-rigid supports, many other variations are possible according to then presently disclosed subject matter. For example, the aerial spraying assembly can comprises three or more supports for supporting the manifold member in spaced spatial relationship with respect to the base structure, wherein at least two of these supports are non-rigid supports, for example corresponding to the non-rigid supports disclosed herein with respect to FIGS. 1 to 3. For example, the two non-rigid supports are spaced from one another along a lateral axis, and the two non-rigid supports are spaced from a third support, which can be for example an adjustable support or a non-adjustable support, along a longitudinal axis, and the respective actuation system can be operated to change the spaced spatial relationship by controlling at least one of a vertical spacing, a roll orientation and a pitch orientation of the manifold member with respect to the base structure. In the above examples in which the third support for supporting the manifold member in spaced spatial relationship with respect to the base structure, is not a non-rigid support, such a third support can be, for example, in the form of a hinge or in the form of a telescopic support, which can change its vertical length but is not flexible. Furthermore, it is also possible to combine the function of conduit 380 integrally with such a third support.

In another example, there are only two non-rigid supports for supporting the manifold member in spaced spatial relationship with respect to the base structure, for example corresponding to the non-rigid supports disclosed herein with respect to FIGS. 1 to 3. The two non-rigid supports can be spaced from one another along a lateral axis, and the actuation system can be operated to change said spaced spatial relationship by controlling at least one of a vertical spacing and a roll orientation of the manifold member with respect to the base structure. Alternatively, the two non-rigid supports can be spaced from one another along a longitudinal axis, and the actuation system can be operated to change the spaced spatial relationship by controlling at least one of a vertical spacing and a pitch orientation of the manifold member with respect to the base structure. In such examples, control of the respective actuation system can be used for stabilizing any barrel roll effects and/or any side drift of the manifold member 300 from port to starboard or vice versa, for example. By operating the respective actuation system to change the spacings of the two. Axially-spaced, non-rigid supports, at specific timings and at specific rates can, at least in some examples, help stabilize the barrel roll effect or side drift effect of the manifold member 300, or can in some cases prevent or minimize the possibility of such phenomena occurring.

In another example, there are only two supports for supporting the manifold member in spaced spatial relationship with respect to the base structure, and only one of the supports is a non-rigid support, for example corresponding to the non-rigid supports disclosed herein with respect to FIGS. 1 to 3, while the other support is not a non-rigid support. The two supports can be spaced from one another along a lateral axis, and the actuation system can be operated to change the spaced spatial relationship by controlling the spacing of the non-rigid support such as to change at least one of a vertical spacing and a roll orientation of the manifold member with respect to the base structure. Alternatively, the two supports can be spaced from one another along a longitudinal axis, and the actuation system can be operated to change the spaced spatial relationship by controlling the spacing of the non-rigid support such as to change at least one of a vertical spacing and a pitch orientation of the manifold member with respect to the base structure. In the above examples in which at least one support for supporting the manifold member in spaced spatial relationship with respect to the base structure, is not a non-rigid support, such a support can be, for example, in the form of a hinge (for example a universal joint) or in the form of a telescopic support, which can change its vertical length but is not flexible.

According to another aspect of the presently disclosed subject matter there is provided an aerial platform and methods of operating the aerial platform for aerial spraying a ground surface.

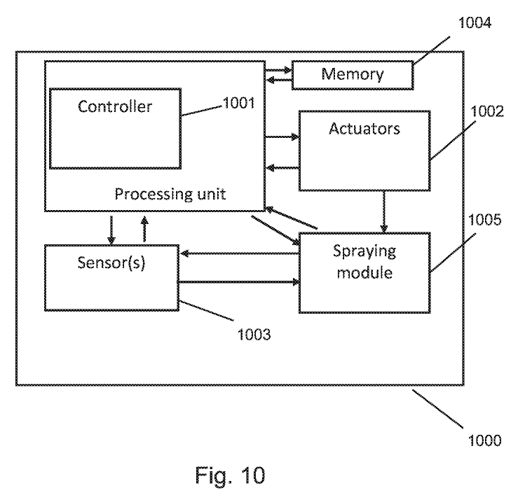

FIG. 10 schematically illustrates an example of such an aerial platform 1000. According to some examples, the aerial platform 1000 can correspond to the air vehicle 900 or alternative variations thereof, as disclosed above with reference to FIGS. 2 to 9. As mentioned for the air vehicle 900, and depending on the examples, the aerial platform 1000 can be for example an unmanned aerial vehicle which is autonomous, or an unmanned aerial vehicle which is at least partially remotely controlled by a human operator and/or via a suitable computer system at the central control CC, or a manned air vehicle.

In the example of FIG. 10, the aerial platform 1000 can comprise at least a spraying module 1005. The spraying module 1005 is configured to spray material M onto a ground surface, and in this example comprises at least the manifold member 300, or alternative variations thereof, as disclosed above with reference to FIG. 1, for example, mutatis mutandis.

The aerial platform 1000 can further comprise one or more sensors 1003, for example one or more of sensors 600, as disclosed above. Depending on the examples, the aerial platform can comprise one or more of the sensors 600 as disclosed above, mutatis mutandis. As mentioned above, these sensors can include e.g. sensors for providing surface data indicative of the three dimensional topography of the ground surface over which the aerial platform is flying and optionally ahead to enable prediction, inertial sensors for providing inertial data of the aerial platform, and one or more inertial sensors for providing inertial data of the spraying module (manifold member), etc.

The aerial platform 1000 can also comprise any additional sensor which is required to control its flight path.

The aerial platform 1000 can also comprise one or more actuators 1002, operatively coupled to the spraying module 1005. The actuators 1002 can in particular control the position of the spraying module 1005, and can include for example the actuation system 800 as disclosed above, mutatis mutandis.

According to some examples, the actuators 1002 are operatively coupled to the spraying module 1005 through at least a non rigid connection. Examples of non rigid connections include winches, cables, springs, etc, and can include for example the non-rigid supports 560 as disclosed above, mutatis mutandis. The spraying module 1005, actuators 1002, and non rigid connection together form an aerial spraying assembly, for example corresponding to the aerial spraying assembly 100 as disclosed above, mutatis mutandis.

According to some examples, and as already disclosed above with respect to FIGS. 1 to 9 regarding aerial spraying assembly 100, the actuators 1002 can comprise a front actuator, a left (or port) actuator, and a right (or starboard) actuator, each operatively coupled to the spraying module 1005 through the aforesaid non rigid connection, and suitable rollers operatively connected to the actuators 1002 can be used to control the extension of the non rigid connectors, and thus the position of the spraying module and its inclination. The inclination of the spraying module includes the pitch angle and/or roll angle.

The aerial platform 1000 further comprises at least a controller 1001 operable on at least a processing unit, for example corresponding to controller 890 as disclosed above, mutatis mutandis. The controller 1001 can communicate with at least a memory 1004 for example corresponding to memory 895 as disclosed above, mutatis mutandis.

It is to be noted that the controller 1001 can be split into a plurality of controllers which are in communication.

According to some examples, if the aerial platform is at least partly controlled remotely from a central control CC, at least part of the steps performed by the controller 1001 can be performed by a remote controller (which also operates on a processing unit). The remote controller can communicate with the aerial platform through its communication unit, for example with a controller embedded in the aerial platform, in order to perform the required steps. It can receive data from the aerial platform, such as data measured by at least a subset of its sensors.

The controller embedded in the aerial platform can then communicate the orders (signals) received from the remote controller e.g. to the actuators of the aerial platform and/or to the actuators of the spraying module.

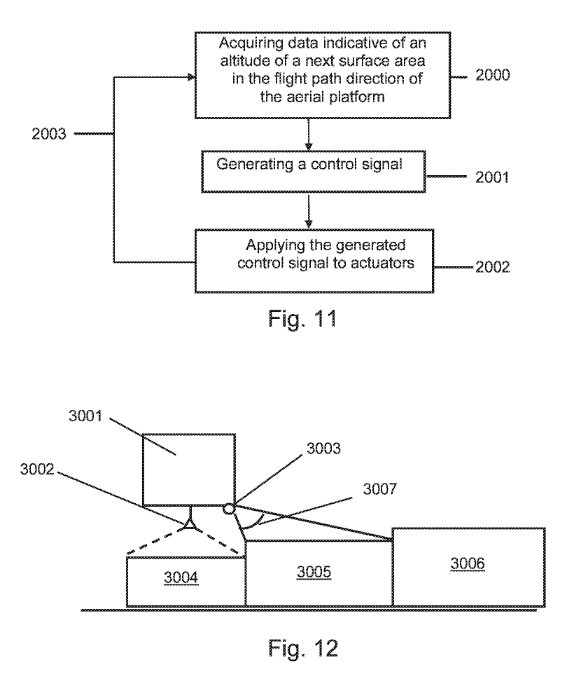

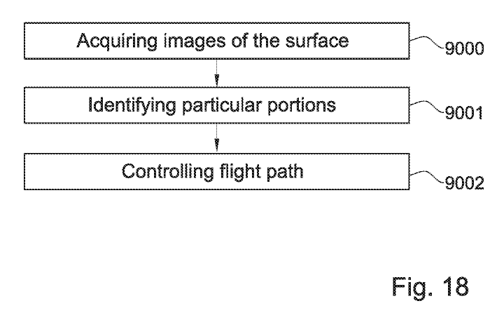

For example, the control of the position and/or inclination of the spraying module (such as the control described with reference e.g. to FIGS. 11, 14, 15, 16, 17) can be performed by the remote controller which communicates with the aerial platform. The same applies to the control of the flight of the aerial platform (such as e.g. the control described with reference e.g. FIGS. 15 and 18).

According to some examples the controller is split into a first controller embedded in the aerial platform and a second controller located in a remote central control CC. Depending on the examples, at least part a first subset of the steps described as performed by the controller 1001 in the various examples can be performed by the first controller, and at least a second subset of the steps described as performed by the controller 1001 in the various examples can be performed by the second controller.

According to some examples, the aerial platform 1000 can also comprise a communication unit (not represented) for emitting and receiving data towards and from a central control station.

The aerial platform 1000 can also comprise additional known components (not represented) of standard aerial platforms (such as wings, actuators for controlling the flight of the aerial platform, propulsion system, etc.). Actuators for controlling the flight of the aerial platform can comprise e.g. a throttle actuator and an elevator actuator.

According to some examples, data computed in the aerial platform 1000 (such as by its sensors and/or by its controller) can be displayed at a remote central station, for example the control center CC as disclosed above with reference to FIG. 1, for example for a pilot who can send remote commands to the UAV 1000, which can be remotely controlled through it via the communication unit.

According to some examples, a stabilization device is used for stabilizing the spraying module, for example corresponding to manifold member stabilizing system 700 as disclosed above, and which can thus for example comprise a passive device (such as aerodynamic spray deflectors) and/or an active device (such as small motors or propellers).

According to some examples, blowers (such as free propellers or other similar devices) can be installed to increase the speed of the spraying droplets and thereby improve the quality of the spraying.

As mentioned, the aerial platform 1000 can be controlled so as to spray a ground surface.

According to some examples, the flight plan of the aerial platform 1000 can be planned in advance.

In particular, reference images can be obtained in advance in order to plan the flight of the aerial platform 1000.

These reference images can be obtained e.g. by performing one or more recognition flight (training flight) of the ground surface to be sprayed. They can also be acquired from public or private sources which provide images of the Earth.

These references images can in particular be used to provide a three dimensional map of the ground surface to be sprayed.

Since the characteristics of the ground surface can be known in advance (in particular, the topography/altitude of the ground surface, and the position of the different elements of the ground surface), it is possible to plan in advance the flight of the aerial platform 1000.

The flight plan (which can comprise in particular the trajectory of the aerial platform 1000, its height during flight, etc.) can be stored in a memory 1004 of the aerial platform 1000. It can also be stored in a memory of the central control CC. If the aerial platform is an UAV, the controller 1001, or another controller of the aerial platform 1000, can then control the different flight actuators (e.g. throttle actuator of the propulsion system, actuators for controlling in flight maneuvering) of the aerial platform 1000 in order to make him perform the desired flight plan. As mentioned, according to some examples, the aerial platform can be controlled by a remote controller at a central remote station according to this flight plan. According to some examples, the aerial platform can be remotely controlled by a human operator according to said flight plan. The flight plan can be displayed to the human operator.

If the aerial platform is a manned vehicle embedding a pilot, this flight plan can be displayed or communicated to the pilot of the manned vehicle, so that the pilot can control the aerial platform to follow this flight plan.

Although the flight plan of the aerial platform can be planned in advance, the controller 1000 (or a remote controller of the aerial platform) can still be able to correct the flight plan, as explained later in the specification, for example to avoid obstacles.

According to some examples, the altitude of the ground surface is known in advance, and stored in a memory, such as the memory 1004 of the aerial platform. During the flight of the aerial platform, the position (and if necessary the attitude) of the aerial platform can be sensed with the sensors of the aerial platform (as mentioned with respect to FIG. 10). Since the position (and possibly the attitude) of the aerial platform is measured, it is possible to locate the aerial platform with respect to the map of the ground surface stored in the memory 1004 (and also to calculate the relative inclination of the spraying module with respect to the ground surface). Thus, according to some examples, during the flight of the aerial platform, the controller 1001 can adjust the position (and if necessary the attitude) of the spraying module with respect to the altitude of the ground surface, in order to comply with predefined requirements (such as a minimum altitude, or a predefined relative attitude with respect to the ground surface). For example, the target position of the spraying module can be computed by the controller by comparing the current position of the spraying module with respect to the ground surface with the minimum desired relative position of the spraying module.

FIG. 11 illustrates an example of a method of controlling the spraying module of an aerial platform.

This method can allow controlling a position of the spraying module 1005 relative to the aerial platform 1000 based on control signals generated during control cycles and applicable to one or more actuators 1002 operatively coupled to the spraying module.

As shown in FIG. 11, the method can comprise a step 2000 of cyclically acquiring data indicative of an altitude of a surface area in the flight path direction of the aerial platform, wherein said surface area is to be sprayed in a next control cycle, or in next control cycles.

While the aerial platform 1000 is flying at a current time (current control cycle) above a surface area of the ground surface (for example ground zone GZ) to be sprayed, it can thus acquire data characterizing the next surface area above which it will fly in a next time (next control cycle(s)).

The duration and frequency of the control cycles can be set in advance in the controller. They can be set as constant during the flight of the aerial platform 1000, or can set as variable, for example depending on the period of the flight trajectory of the aerial platform 1000. They can also be adjusted during the flight of the aerial platform 1000 by the controller.

A simplified and non limitative example of the method of FIG. 11 is illustrated in FIG. 12.

As shown in FIG. 12, the aerial platform 3001 (corresponding to the aerial platform 1000 for example) is currently flying above a surface area 3004. The spraying module 3002 is spraying fluid material on said surface area 3004. At the same time, a sensor 3003 (e.g. embedded on the aerial platform) is acquiring data indicative of the altitude of the surface area 3005, which is to be sprayed by the aerial platform in a next control cycle (or in next control cycles).

This acquisition of data can allow predicting the altitude of the surface in a future time, and thus allows controlling in advance the position of the aerial platform and/or the position of the spraying module, in order to cope with a change of the altitude and/or the apparition of obstacles.

The controller 1001 receives the data indicative of an altitude of the surface area which is to be sprayed in a next control cycle, and can thus generate at least a control signal based on at least said acquired data (step 2001). This control signal can be applied to the actuators 1002 of the spraying module, in order to control its position relatively to the aerial platform.

In particular, this control signal can be computed to maintain the altitude of the spraying module 1005 at a required distance of the altitude of the surface. This required distance can comprise a minimal height between the spraying module and the altitude of the surface. It can also comprise a fixed height (or at least a fixed height interval) of the spraying module with respect to the altitude of the surface. According to some examples, the attitude of the spraying module 1005 is also controlled, e.g. so as to maintain the spraying module 1005 parallel to the ground surface.

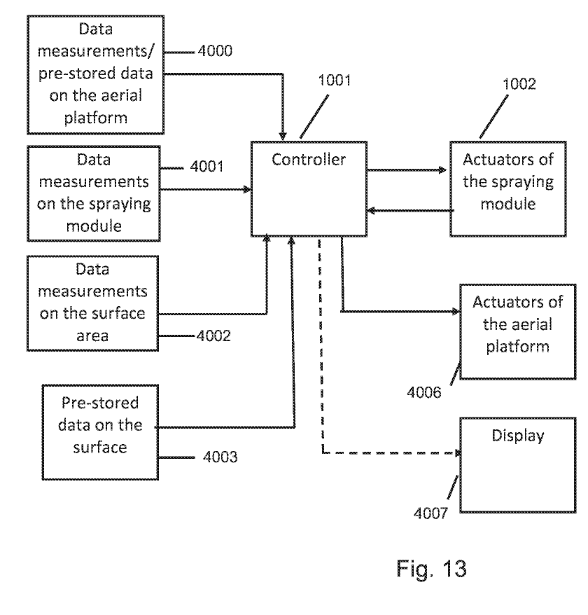

In order to compute the control signal, the controller 1001 can take into account various data (see e.g. FIG. 13). Although various data are represented, it is to be noted that this representation is not limitative. As mentioned, if the aerial platform is controlled by a remote controller, at least part of the functions performed by the controller 1001 can be performed by said remote controller, which can communicate with the aerial platform through a communication unit.

The controller 1001 can receive data 4000 on the aerial platform, and in particular, inertial data such as position, velocity, attitude, etc. These data can be measured during the flight by position and velocity sensors.

If the flight plan of the aerial platform 1000 was planned in advance, the controller 1001 can also access pre-stored data related to the flight plan of the aerial platform.

If necessary, the aerial platform 1000 can receive auto-pilot output, that is to say the command of roll, pitch, etc. that are applied to the aerial platform 1000. This can be used for a feed forward function.

The controller 1001 can receive data measurements 4001 on the spraying module, such as its position, velocity, etc. The position and the velocity can be measured by known position sensors and velocity sensors.

The controller 1001 can also receive data measurements 4002 indicative of the altitude of the surface area that is to be sprayed in next control cycle, as explained with reference to FIG. 12.

The controller 1001 can also receive pre-stored data 4003 on the ground surface (such as pre stored reference images of the ground surface, or pre stored data on the profile of the altitude of the ground surface, etc.).

The controller 1001 can receive a target for the required distance between the spraying module and the ground surface. This target can be set as a constant value during the flight of the aerial platform, or can vary, depending on the needs of the operator (or pilot) of the aerial platform.

The controller 1001 can also access pre-stored data on the aerial platform and/or the spraying module (such as mass, inertia, etc.).

If necessary, the controller 1001 can output data on a display 4007. If the aerial platform is an UAV, this can allow a pilot to remotely control the UAV, e.g. from a remote central station. If the aerial platform is a manned vehicle, this can allow the pilot of the manned air vehicle to access the displayed data.

The controller 1001 can comprise a filter, such as Kalman filter, in order to compute a control signal for the actuators 1002 of the spraying module, based on the data it receives as an input. This control signal is computed to allow the spraying module to comply at least with the required distance 4003 between said spraying module and the altitude of the surface to be sprayed. This control signal can also be computed to control the inclination of the spraying module.

The control signal can for example comprise the profile of the force that the actuators 1002 need to apply to the spraying module.

According to some examples, the controller 1001 can compute a control signal for the actuators 4006 of the aerial platform. This control signal can thus induce a change in the trajectory of the aerial platform. For example, if the controller has detected that it is not possible to comply with the required distance with respect to the surface area to be sprayed in a next control cycle, it can compute a control signal in order to change the position of the aerial platform.

The controller 1001 can detect that it is not possible to comply with said required distance based on several criteria.

For example, since the available position range of the spraying module with respect to the aerial platform (which varies between a minimal position and a maximal position, and depends notably on the actuators range) is limited, the controller 1001 can detect that this limitation prevents the spraying module from complying with the required distance in the next control cycle. This can arise for instance when a new high obstacle has appeared on the surface area to be sprayed.

In addition, the controller 1001 can also detect that in view of the velocity of the aerial platform, and in view of the maximum velocity of the motion of the spraying module, it is not possible to change the position of the spraying module in time, so as to comply in the next control cycle with the required distance with respect to the surface area to be sprayed in said next control cycle. As a consequence, the controller 1001 has to change the trajectory of the aerial platform (it can also change the position of the spraying module if necessary).

The controller 1001 can also instruct the spraying module to perform a quick ascend phase, together with a quick ascension of the aerial platform, to avoid a collision with an obstacle.

According to some examples, the controller 1001 is configured to control an inclination of the spraying module with respect to the aerial platform.

Depending on the numbers of actuators, it is possible according to some examples to control not only the position of the spraying module with respect to the UAV, but also its inclination with respect to the UAV (such as the angles of pitch and/or roll).

Examples of actuators which can allow the control of the inclination of the spraying module have been described with reference to FIG. 1. These examples are only examples and different actuators can be used.

In order to control the inclination, the controller 1001 can send different control signals to the different actuators of the spraying module, so as to cause an inclination of the spraying module. For example, an actuator controlling the position of a first extremity of the spraying module can receive a control signal which corresponds to the application of a stronger force than the control signal sent to an actuator controlling the position of the other extremity of the spraying module. This control is a non limiting example.

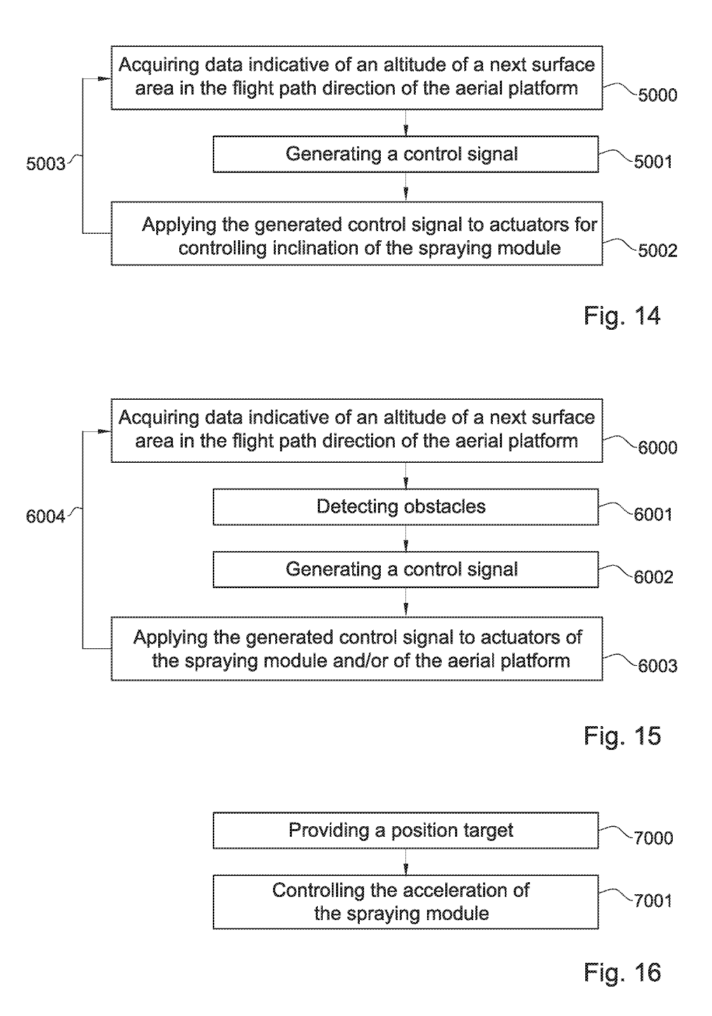

According to some examples, and as shown in FIG. 14, the controller 1001 controls the inclination of the spraying module with respect to a surface area of the ground surface to be sprayed in a next control cycle.

Steps 5000, 5001 and 5003 are similar to steps 2000, 2001 and 2003, mutatis mutandis.

The controller can for example take into account the fact that the surface area to be sprayed in a next control cycle is inclined, which requires causing an inclination of the spraying module. Thus, at step 5002, the appropriate control signal is sent to the actuators of the spraying module, in order to take into account said surface area to be sprayed in a next control cycle.

In particular, since the controller 1001 receives data on the next surface to be sprayed, it can adjust the inclination of the spraying module in the current control cycle for complying with the surface to be sprayed in a next control cycle.

According to some examples, the controller 1001 controls an inclination of the spraying module with respect to the aerial platform so as to maintain the spraying module substantially parallel to the surface. The roll angle and/or the pitch angle of the spraying module can typically be controlled. For example, if the aerial platform is flying along a slope of the ground surface, the pitch angle of the spraying module can be controlled so as to maintain the spraying module parallel to the ground surface. In another example, if the aerial platform is flying along a direction perpendicular to a slope, the roll angle of the spraying module can be controlled.

According to some examples, even if the aerial platform is to perform a maneuver which implies an inclination of the aerial platform, the spraying module can thus stay parallel to the ground surface to be sprayed.

According to some examples, the controller 1001 accesses data on the flight plan of the aerial platform, which can comprise predictions of at least the attitude and/or the position of the aerial platform in next control cycle(s). These predictions can be for example stored in the flight plan of the aerial platform that was computed before the flight. According to some other examples, the prediction is based on real time data collection.

Since the controller 1001 receives data on the future attitude of the UAV, it can compute in advance the appropriate control signal for controlling the inclination and/or position of the spraying module.

The controller 1001 can also control the different parameters of the spraying (such as pressure, provision; opening/closing of the sprinklers or spray nozzles 310, etc.).

In order to acquire data indicative of the topography/altitude of the surface area to be sprayed in a next control cycle, different types of sensors 3003 can be used.

According to some examples, an image sensor (e.g. a camera) can be used. The image sensor can acquire a video, or alternatively, a sequence of images.

According to some examples, a sensor allowing 3D imaging is used.

The acquisition of data (step 2000 of FIG. 11) can thus comprise taking images of the surface area which is to be sprayed in a next control cycle. An image processing algorithm can then provide the altitude of the surface based on the acquired data. Known per se software can be used such as PIX4D or Recap 360 (these examples are not limitative).

According to some examples, sensors using waves are used, such as radar, LIDAR, acoustic sensor, etc. This list is not limitative.

According to some examples, a 2D sensor is used, or a 3D sensor. If a 2D sensor is used, an algorithm to convert the 2D data into 3D data can be used. Known per se software can be used such as PIX4D or Recap 360 (these examples are not limitative).

According to some examples, a system of cameras is used (for example stereoscopic cameras).

According to some examples, a sensor which can acquire data during the day and during the night is used.

According to some examples, a plurality of sensors is used for acquiring data indicative of the altitude of the surface area to be sprayed in a next control cycle. Different types of sensors can be used, for example to improve the quality of the signal.

According to some examples, the inclination of the sensor 3003 with respect to the aerial platform can be controlled and changed by the controller 1001 during the flight of the aerial platform, in order to change the line sight of the sensor with respect to the surface. Appropriate actuators (such as mechanical actuators, or electro-mechanical actuators) can be used to control the inclination of the sensor 3003.

As shown in FIG. 12, the field of view 3007 of the sensor 3003 depends on the sensor that is used. The surface area that can be viewed by the sensor depends notably on this field of view 3007.

As shown in FIG. 12, the field of view 3007 can allow at least acquiring data on a surface area which is at the current time not totally below the aerial platform. According to some examples, it can allow acquiring data on a surface area 3005 which is, during the current control cycle, not below the aerial platform (such as surface area 3005 in FIG. 12). The field of view can be chosen to allow acquiring data from above the aerial platform in order to detect other air vehicles in the vicinity.

The field of view 3007 can be chosen so as to acquire data on surface areas that will be sprayed by the aerial platform not only in the immediate next control cycles, but also in further control cycles, such as surface are 3006, or other surface areas.

According to some examples, the at least one sensor 3003 can be configured to measure also data indicative of the altitude of the surface area above which the aerial platform is currently flying (that is to say during the current control cycle). This depends notably on the field of view 3007 of the sensor 3003.

In this case, it is possible to use the sensor 3003 also as a sensor for measuring the current altitude of the UAV with respect to the surface.

According to some examples, and as shown in FIG. 15, a method of detecting obstacles can be carried out. Obstacles can include for example elements of the surface or flying object(s) flying above surface that do not need to be sprayed, such as vehicles, animals, houses, other air vehicles, etc. The definition of the obstacles can be set by a user and can depend on the detecting method.

Data indicative of an altitude of a next surface area in the flight path direction of the aerial platform are acquired (step 6000, similar to steps 2000 and 5000).

If the data are images of the surface area, the method can comprise comparing the acquired data with pre-stored reference images of the surface, so as to detect obstacles in the surface.

In particular, the acquired data, which reflect a particular surface area of the ground surface, can be compared to the corresponding surface area in the pre-stored reference images. The selection of the corresponding surface area in the pre-stored reference images can comprise the steps of measuring the position of the aerial platform, and, based on this measurement (and also on the field of view of the sensor), extracting the corresponding relevant surface area in the pre-stored reference images.

If the data are not images (such as data measured by a radar, or a LIDAR) they can be compared to pre-stored data on the altitude of the surface (such as altitude data provided by a three-dimensional map of the surface). They can be compared to the mean value of the pre-stored data of the altitude, or to pre-stored data of the altitude of each surface area.

The comparison with pre-stored reference data can allow detecting the presence of obstacles.

According to some examples, any difference identified between the measured data and the reference data can be considered by the controller 1001 as obstacles.

According to some examples, the controller 1001 can send a command to the spraying module for reducing or stopping spraying in a next control cycle, if an obstacle was detected.

In addition, depending on the altitude of the obstacle, the controller 1001 can compute appropriate control signals for the actuators of the spraying module in order to maintain the required distance with the obstacles, as already mentioned with respect e.g. to FIG. 11.

If necessary, the controller 1001 can send a control signal to the actuators of the aerial platform in order to adjust the altitude of the aerial platform, if the obstacle has an altitude for which it is insufficient to control only the position of the spraying module.

According to some examples, when an obstacle is identified, the controller 1001 can send a control signal to the actuators of the aerial platform in order to change the flight plan of the aerial platform and avoid the obstacle. The position of the obstacle can be stored in a memory 1004 and can be used to recalculate the flight plan of the aerial platform so as to allow the aerial platform to cover the whole surface except this position.

According to some examples, the data acquired by the sensor and which are indicative of an altitude of a next surface area, are not compared to pre-stored reference data indicative of the altitude of the surface.

The evolution of the acquired data can thus be analyzed so as to detect obstacles in the surface. Rapid or brutal changes in the evolution of the altitude can be considered by the controller 1001 as indicative of an obstacle. A threshold can be set.

According to other examples, image recognition or form recognition algorithms are applied to the data. Image recognition can be used to detect obstacles that are not to be sprayed (such as animals, vehicles, etc.). Known algorithms, such as Vantage 3D Obstacle Detection and Avoidance, can be used (this example is not limitative).

Examples for controlling the motion of the spraying module will now be described, in particular with reference to FIG. 16.

As explained in the various previous examples, the controller 1001 can compute a position target (step 7000) to be reached by the spraying module (depending e.g. on the surface area to be sprayed, the obstacles, etc.) and compute an appropriate control signal to be applied to the actuators for reaching said position target.

According to some examples, the controller 1001 further controls at least an acceleration of the motion of the spraying module for reaching said position target.

In particular, this control can allow the spraying module to reach the position target without overshoot (or with a reduced overshoot, below a predefined threshold).

According to some examples, this control can be performed when the spraying module is connected to the aerial platform by at least a non-rigid connection. Various examples of actuators comprising a non-rigid connection have been described with reference to FIG. 1. They include for example winches, cables, springs, etc. (this list being not limitative) which connect the spraying module to the aerial platform and can be controlled by the controller 1001.

According to some examples, the controller controls a damping in the motion of the spraying module.

According to some examples, the control method can comprise:
measuring a position and a velocity of the spraying module, and
computing a control signal based at least on a damped combination of the measured position and velocity.

This damped combination allows the spraying module to reach the position target without overshooting the target or being subject to undesired oscillations.

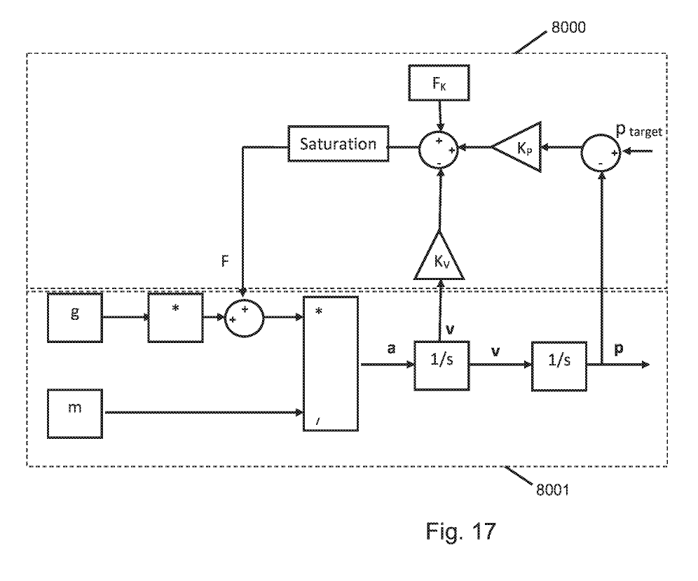

A particular control loop for controlling the acceleration of the spraying module is described in FIG. 17. This control loop can be implemented in the controller 1001. It is to be noted that this example is an illustrative example and non limitative example. In this figure, ‘m’ is the mass of the spraying module and ‘g’ the acceleration of the Earth due to gravity. In this figure, the blocks belonging to the reference number 8000 are part of the control loop, and the blocks belonging to the reference number 8001 simulate the physics of the spraying module (p, v, and a are respectively the position, velocity and acceleration of the spraying module along the up and down axis).

The control loop controls the position of the spraying module, and has an impact on the acceleration of the motion of the spraying module.

In this control loop, the controller 1001 provides a position target p_{target}. This position target is computed by the controller 1001 according to the various examples described previously, e.g. depending on the measured altitude of the surface to be sprayed, the altitude of the aerial platform, the required distance with the surface, etc.

The current position ‘p’ and the current velocity ‘v’ of the spraying module are measured (e.g. by position sensor or velocity sensors mounted on the spraying module). According to some examples, the velocity is measured by a winch controller (using a potentiometer, optic encoder, magnetic encoder, back EMF [in case of electric motor], or any other device) or using an independent external device (the same sensors can be used).

A control signal which can be the force F that the actuator needs to apply to the spraying module is computed. The control loop can first compute a first signal based on the difference between:
the position error (p_{target}-p) multiplied by a damping coefficient K_{P}, and
the velocity measurement multiplied by a damping coefficient K_{V}.

Non limitative values for K_{P} and K_{V} can be for example: K_{P}=200 and K_{V}=150.

The control loop can add to this first signal a constant (constant F_{K}) to eliminate or reduce the steady state error created by the spraying module weight. Indeed, the weight of the spraying module is generating a constant force downwards, and the constant F_{K} generates a force in reverse direction to balance this downwards constant force. In addition, a threshold (saturation) can be introduced in the control loop, which suppresses part of the signal which is above this threshold. This allows the force to be applied to remain only in one direction. Indeed, in some examples, the non rigid connection works in tension and a change in the value of the compression with respect to mean value can allow raising or lowering the spraying module.

In reference to FIG. 18, an example of a method of controlling the flight path of the aerial platform is described.

The method can comprise a step 9000 of acquiring images of the surface. Images of the current surface on which the aerial platform is flying can be taken. An image sensor can be used, which can be the same as the sensor 3003, or an additional sensor embedded in the aerial platform. If necessary, images of the ground surface that is to be sprayed in next control cycles are taken.

The method can comprise a step 9001 of identifying particular portions of the ground surface in the images. The identification of particular portions can be performed by using at least an image processing algorithm. Particular portions include for examples edge and/or borders of the surface. Indeed, when the aerial platform is used to spray a surface such as a field, said surface generally comprises identifiable limitations with respect to the adjacent surfaces. For example, the border of the field can be viewed in the images.

The method can then comprise a step 9002 of controlling the flight path of the aerial platform based on this identification.

In particular, if the controller 1001 is able to identify the limits of the surface, it can control its flight path so as to ensure that the UAV is not flying out of the surface to be sprayed. This can be required for security reasons.

The control of the aerial platform based on at least these steps can be useful in particular when an information on the current position of the aerial platform is not available. For example, the aerial platform can have lost its connection with GPS satellites, or its sensor position can be inoperable.

In this case, even if the information on the current position of the aerial platform is not available (or is available but with insufficient precision to allow a control of the flight), the method can ensure a control of the flight of the aerial platform.

According to some examples, the aerial platform is controlled to land on a predefined rescue position, based on the identification of particular portions of the surface.

According to some examples, the aerial platform is controlled to follow a border of the ground surface and to reach a rescue position.

According to some examples, the method can comprise computing the position of the aerial platform based on this identification.

A step of comparing the identified portions with pre-stored data comprising reference images of the surface can be performed, in order to estimate the position of the aerial platform.

As already mentioned, the controller which controls the flight path of the aerial platform can be embedded in the aerial platform or can be located in a remote control station, or the controller can be split between at least a first controller embedded in the aerial platform and a second controller located in the remote control station.

The presently disclosed subject matter contemplates a computer program being readable by a computer for executing one or more methods of the presently disclosed subject matter. The presently disclosed subject matter further contemplates a machine-readable memory tangibly embodying a program of instructions executable by the machine for executing one or more methods of the presently disclosed subject matter.

It is to be noted that the various features described in the various examples can be combined according to all possible technical combinations.

It is to be understood that the presently disclosed subject matter is not limited in its application to the details set forth in the description contained herein or illustrated in the drawings. The presently disclosed subject matter is capable of other examples and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

Those skilled in the art will readily appreciate that various modifications and changes can be applied to the examples of the presently disclosed subject matter as hereinbefore described without departing from its scope, defined in and by the appended claims.

In the method claims that follow, alphanumeric characters and Roman numerals used to designate claim steps are provided for convenience only and do not imply any particular order of performing the steps.

Finally, it should be noted that the word “comprising” as used throughout the appended claims is to be interpreted to mean “including but not limited to”.

1. A method of controlling a spraying module of an aerial platform, the spraying module being configured to spray fluid material on a surface, the method comprising, during the flight of the aerial platform:
controlling a position of the spraying module relatively to the aerial platform based on control signals generated during control cycles and applicable to one or more actuators operatively coupled to the spraying module, the controlling comprising:
cyclically acquiring data indicative of an altitude of a surface area in the flight path direction of the aerial platform, wherein said surface area is to be sprayed in a next control cycle,
generating a control signal based on at least said acquired data, so as to maintain the altitude of the spraying module at a required distance of the altitude of the surface, and
applying the generated control signal to the one or more actuators.

2. The method according to claim 1, wherein said acquisition of data comprises taking images of the surface area which is to be sprayed in a next control cycle.

3. The method according to claim 1 or claim 2, comprising:
comparing the acquired data with pre-stored reference images of the surface, so as to detect obstacles in the surface.

4. The method according to any one of claims 1 to 3, comprising:
performing an analysis of the evolution of the acquired data, so as to detect obstacles in the surface.

5. The method according to any of claims 1 to 4, comprising:
adapting a spraying period of the spraying module and/or a flight path of the aerial platform based on the detection of obstacles.

6. The method according to any one of claims 1 to 5, comprising planning in advance a flight path of the aerial platform based on pre-stored data on the altitude of surface.

7. The method according to any one of claims 1 to 6, further comprising controlling an inclination of the spraying module with respect to the aerial platform.

8. The method according to claim 7, comprising controlling an inclination of the spraying module with respect to the aerial platform so as to maintain the spraying module substantially parallel to the surface.

9. The method according to any one of claims 1 to 8, comprising controlling an inclination and/or a position of the spraying module with respect to the aerial platform based on predictions of at least the attitude and/or the position of the aerial platform.

10. The method according to any one of claims 1 to 9, wherein the spraying module is connected to the aerial platform by at least a non-rigid connection.

11. The method according to any one of claims 1 to 10, further comprising
controlling the spraying module to reach a target position, and
controlling an acceleration of a motion of the spraying module for reaching said target position.

12. The method according to any one of claims 1 to 11, further comprising controlling a damping in the motion of the spraying module.

13. The method according to any one of claims 1 to 12, comprising:
measuring a position and a velocity of the spraying module, and
computing a control signal based at least on a damped combination of the measured position and velocity.

14. The method according to any one of claims 1 to 13, further comprising:
acquiring images of the surface from the aerial platform,
identifying particular portions of the surface in the images, and
controlling the flight path of the aerial platform based on this identification.

15. The method according to any one of claims 1 to 14, further comprising:
controlling the flight path of the aerial platform based on this identification, even if an information on the current position of the aerial platform is not available.

16. The method according to any one of claims 14 to 15, wherein the particular portions include edges and/or borders of the surface.

17. A method of controlling a spraying module of an aerial platform, the spraying module being loosely connected to the spraying module and being configured to spray fluid material on a surface, the method comprising, during the flight of the aerial platform:
controlling the spraying module so as to reach a position target relatively to the aerial platform, and
controlling at least an acceleration of the motion of the spraying module for reaching said position target.

18. The method according to claim 17, further comprising controlling a damping in the motion of the spraying module.

19. The method according to claim 17 or claim 18, comprising introducing a selected damping in the motion of the spraying module which ensures that the position of the spraying module does not go beyond the position target.

20. The method according to any one of claims 17 to 19, comprising:
measuring a position and a velocity of the spraying module, and
computing a control signal based at least on a damped combination of the measured position and velocity, for controlling the acceleration of the motion of the spraying module.

21. The method according to any one of claims 17 to 20, comprising:
controlling a position of the spraying module relatively to the aerial platform based on control signals generated during control cycles and applicable to one or more actuators operatively coupled to the spraying module, the controlling comprising:
cyclically acquiring data indicative of an altitude of a surface area in the flight path direction of the aerial platform, wherein said surface area is to be sprayed in a next control cycle,
generating a control signal based on at least said acquired data, so as to make the spraying module reach a position target which is at a required distance of the altitude of the surface, and
applying the generated control signal to the one or more actuators.

22. An aerial platform comprising:
a spraying module being configured to spray fluid material on a surface,
one or more actuators operatively coupled to the spraying module,
at least a sensor for acquiring data indicative of altitude,
wherein at least a controller located in at least one of the aerial platform and a control station is configured to control a position of the spraying module relatively to the aerial platform based on control signals generated during control cycles and applicable to the one or more actuators, the controlling comprising:
cyclically acquiring with said sensor data indicative of an altitude of a surface area in the flight path direction of the aerial platform, wherein said surface area is to be sprayed in a next control cycle,
generating a control signal based on at least said acquired data, so as to maintain the altitude of the spraying module at a required distance of the altitude of the surface, and
applying the generated control signal to the one or more actuators.

23. The aerial platform according to claim 22, wherein the sensor comprises at least an image sensor configured to take images of the surface area which is to be sprayed by the aerial platform during a next control cycle.

24. The aerial platform according to claim 22 or claim 23, wherein the controller is further configured to compare the acquired data with pre-stored reference images of the surface, so as to detect obstacles in the surface.

25. The aerial platform according to any one of claims 22 to 24, wherein the controller is further configured to perform an analysis of the evolution of the acquired data, so as to detect obstacles in the surface.

26. The aerial platform according to any of claim 24 or 25, wherein the controller is further configured to adapt a spraying period of the spraying module and/or a flight path of the aerial platform based on the detection of the obstacles.

27. The aerial platform according to any one of claims 22 to 26, wherein a flight path of said aerial platform is controlled according to a flight path which is computed in advance based on pre-stored data on the altitude of surface.

28. The aerial platform according to any one of claims 22 to 27, wherein the controller is further configured to control inclination of the spraying module with respect to the aerial platform.

29. The aerial platform according to any one of claims 22 to 28, wherein the controller is further configured to control an inclination of the spraying module with respect to the aerial platform so as to maintain the spraying module substantially parallel to the surface.

30. The aerial platform according to any one of claims 22 to 29, wherein the controller is further configured to control an inclination and/or a position of the spraying module with respect to the aerial platform based on predictions of at least the attitude and/or the position of the aerial platform.

31. The aerial platform according to any one of claims 22 to 30, wherein the spraying module is connected to the aerial platform by at least a non-rigid connection.

32. The aerial platform according to any one of claims 22 to 31, wherein the controller is further configured to:
control the spraying module to reach a target position, and
control an acceleration of a motion of the spraying module for reaching said target position.

33. The aerial platform according to any one of claims 22 to 32, wherein the controller is further configured to control a damping in the motion of the spraying module.

34. The aerial platform according to any one of claims 22 to 33, further comprising at least a sensor for measuring a position and a velocity of the spraying module, wherein the controller is further configured to compute a control signal based at least on a damped combination of the measured position and velocity.

35. The aerial platform according to any one of claims 22 to 34, further comprising at least a sensor for acquiring images of the surface from the aerial platform, wherein the controller is configured to:
identify particular portions of the surface in the images, and
control the flight path of the aerial platform based on this identification.

36. The aerial platform according to any one of claims 22 to 35, wherein the controller is configured to control the flight path of the aerial platform based on this identification, even if an information on the current position of the aerial platform is not available.

37. The aerial platform according to any one of claims 35 to 36, wherein the particular portions include edges and/or borders of the surface.

38. The aerial platform according to any one of claims 22 to 37, wherein the aerial platform is an unmanned air vehicle (UAV).

39. An aerial platform comprising:
a spraying module being configured to spray fluid material on a surface, and
one or more actuators operatively coupled to the spraying module by at least a non rigid connection,
wherein at least a controller located in at least one of the aerial platform and a control station is configured to:
control the spraying module so as to reach a position target relatively to the aerial platform, and
generate a control signal for controlling at least an acceleration of the motion of the spraying module for reaching said position target.

40. The aerial platform according to claim 39, comprising at least a sensor for measuring a position and a velocity of the spraying module, wherein the controller is configured to compute a control signal based at least on a damped combination of the measured position and velocity, for controlling the acceleration of the motion of the spraying module.

41. The aerial platform according to claim 39 or claim 40, wherein the controller is configured to:
control a position of the spraying module relatively to the aerial platform based on control signals generated during control cycles and applicable to one or more actuators operatively coupled to the spraying module, the controlling comprising:
cyclically acquiring data indicative of an altitude of a surface area in the flight path direction of the aerial platform, wherein said surface area is to be sprayed in a next control cycle,
generating a control signal based on at least said acquired data, so as to make the spraying module reach a position target which is at a required distance of the altitude of the surface,
applying the generated control signal to the one or more actuators.

42. The aerial platform according to any one of claims 39 to 41, wherein the aerial platform is an unmanned air vehicle (UAV).

43. A controller for controlling a spraying module of an aerial platform, the spraying module being configured to spray fluid material on a surface, the controller being configured to, during the flight of the aerial platform:
control a position of the spraying module relatively to the aerial platform based on control signals generated during control cycles and applicable to one or more actuators operatively coupled to the spraying module, the controlling comprising:
cyclically acquiring data indicative of an altitude of a surface area in the flight path direction of the aerial platform, wherein said surface area is to be sprayed in a next control cycle,
generating a control signal based on at least said acquired data, so as to maintain the altitude of the spraying module at a required distance of the altitude of the surface, and
applying the generated control signal to the one or more actuators.

44. The controller according to claim 43, wherein the spraying module is connected to the aerial platform by at least a non-rigid connection.

45. The controller according to claim 43 or claim 44, configured to:
control the spraying module to reach a target position, and
control an acceleration of a motion of the spraying module for reaching said target position.

46. The controller according to any one of claims 43 to 45, configured to control a damping in the motion of the spraying module.

47. The controller according to any one of claims 43 to 46, configured to:
receive a position and a velocity measurement of the spraying module,
compute a control signal based at least on a damped combination of the measured position and velocity.

48. A controller for controlling a spraying module of an aerial platform, the spraying module being loosely connected to the aerial platform and being configured to spray fluid material on a surface, the controller being configured to:
control the spraying module so as to reach a position target relatively to the aerial platform, and
generate a control signal for controlling at least an acceleration of the motion of the spraying module for reaching said position target.

49. A non-transitory storage device readable by a machine, tangibly embodying a program of instructions executable by the machine to perform a method of controlling a spraying module of an aerial platform, the spraying module being configured to spray chemical products on a surface, the method comprising, during the flight of the aerial platform:
controlling a position of the spraying module relatively to the aerial platform based on control signals generated during control cycles and applicable to one or more actuators operatively coupled to the spraying module, the controlling comprising:
cyclically acquiring data indicative of an altitude of a surface area in the flight path direction of the aerial platform, wherein said surface area is to be sprayed in a next control cycle,
generating a control signal based on at least said acquired data, so as to maintain the altitude of the spraying module at a required distance of the altitude of the surface, and
applying the generated control signal to the one or more actuators.

50. A non-transitory storage device readable by a machine, tangibly embodying a program of instructions executable by the machine to perform a method of controlling a spraying module of an aerial platform, the spraying module being configured to spray fluid material on a surface, the method comprising, during the flight of the aerial platform:
controlling the spraying module so as to reach a position target relatively to the aerial platform, and
controlling at least an acceleration of the motion of the spraying module for reaching said position target.
